(19) United States
(12) Patent Application Publication
(10) Pub. No.: US 2020/0111268 A1
(43) Pub. Date: Apr. 9, 2020

(54) MULTI-MODAL TRAVEL SYSTEM FOR PARKING AND SECOND MODE VEHICLE RENTALS

(71) Applicants: David MONTAGUE, Cambridge, MA (US); Gabriel MONTAGUE, Cambridge, MA (US); Alexander MONTAGUE, Cambridge, MA (US)

(72) Inventors: David MONTAGUE, Cambridge, MA (US); Gabriel MONTAGUE, Cambridge, MA (US); Alexander MONTAGUE, Cambridge, MA (US)

(21) Appl. No.: 16/151,932

(22) Filed: Oct. 4, 2018

(51) Int. Cl. G07B 15/02; G06F 17/30; G06Q 30/06; G01C 21/34; G01C 21/36

(52) U.S. Cl. CPC G07B 15/02; G06F 17/30241; G01C 21/3697; G01C 21/3423; G01C 21/3685; G06Q 30/0645

(57) ABSTRACT

A system, method, and user interface for multi-modal travel wherein a server stores mode transition locations at which a user transfers between a first mode of transportation, such as a car, and a second mode of transportation, such as a bicycle or scooter, and wherein the user can rent parking spaces for vehicles and/or rent second mode of transportation vehicles such as bike share bicycles or scooters; and wherein the system may provide the user with a reservations systems and/or suggested routes and mode transition locations based in some cases on a user location or starting and destination addresses, and the system may provide navigation directions during travel.

### BACKGROUND

### 1. Field

This invention relates to the system, method, user interface, and computer software program for multi-modal travel wherein a server stores mode transition locations at which a user transfers between a first mode of transportation, such as a car, and a second mode of transportation, such as a bicycle or scooter, and where the user can 1) rent parking spaces for a mode of transportation and 2) rent a second mode of transportation such as bicycles or scooters; and wherein a user device may provide the user with additional features such as a) suggested routes and mode transition locations based at least in part on a user location or starting and destination addresses, b) unlocking and locking of access to the second mode of transportation, c) a reservations for the rentable items, and d) navigation directions during travel.

Furthermore, this invention relates to the user interface with the system and how the user manipulates the system to meet his or her travel mode requirements. One aspect of the system offers a novel method of selecting mode transition locations, and modes of travel, and returns a suggested result based on user location, or initial user input, and then offers a novel method of allowing the suggested result to be further modified to match the user's requirements.

### 2. Description of Related Art

Bike and scooter share programs in urban environments for urban users have become ubiquitous. One-way dockless and docked bike and scooter share rentals allow users to rent a bike, and return it in a different location. For dockless bike share, bikes often can be left in a somewhat random location based on geography, while docked bikes require them to be returned to a docking station. However, bike or scooter share program for suburban commuters are not available, as distances are larger, and easy access to an available bike or scooter can be problematic. Furthermore, using a one way bike or scooter share vehicle for commuting to work can be challenging as the bike or scooter used to get to work may have been rented by someone else and no longer be available for the return trip.

Bike and scooter share programs have prospered because traffic in urban and suburban environments is becoming increasingly problematic for travelers as the number of vehicles and the number of commuters increases. Often there are segments of a journey that are better served by a larger high speed vehicle such as a car or truck, herein called a personal motorized highway transportation vehicle, and segments of a journey that are better served by a personal vehicle appropriate for travel on urban and suburban roadways, such as a bicycle, electric Bike (ebike), scooter, electric scooter, motor-scooter, moped, neighborhood electric vehicle (NEV) or other one or more wheeled vehicle, herein called a personal roadway transportation vehicle. It should be noted that the inclusion of the word “motorized” in the term “personal motorized highway transportation vehicle” and not in the term “personal roadway transportation vehicle” does not indicate that personal roadway transportation vehicles exclude vehicles that are motorized.

Using multiple modes of transport (multimodal) often allows the traveler to complete a journey in the shortest amount of time, or in the most economical way, and within the physical abilities of the user. For example, riding a bicycle a long distance from a suburban home to an urban office, where the quickest route may be mostly on a highway, is often not practical. However, gridlock traffic in urban environments can render a car less ideal for the “last mile” while bicycles offer more utility. In addition, parking a bicycle in the city is most often quick to do, and is generally free, while parking a car can be very expensive, and may take additional time. Therefore providing a simple and intuitive method for the user to assess his or her options and allow them to utilize the most efficient mode for each part of the journey is desirable.

### SUMMARY

It is an objective of the present invention to set forth a system that facilitates multi-modal commuting by offering rentals of parking spaces and personal roadway transportation vehicles from conveniently placed mode transition locations. Mode transition locations may be owned and/or operated by an independent third party, herein referred to as the purveyor of the mode transition location, or owned and/or operated by a owner of the system or the application manager who runs the system (collectively referred to as the app manager), and therefore references made to the purveyor are also references to the app manager as well. A mode transition location is a location where a user transfers between a first mode of transportation and a second mode of transportation, the first mode of transportation comprising a personal motorized highway transportation vehicle and the second mode of transportation comprising a personal roadway transportation vehicle. It should be noted that “first” and “second” are used as differentiators, and are not intended to indicate an order of events. Mode transition locations may be located at institutional or commercial establishments (e.g. a retail store), or at private residences where there is, for example, excess parking or convenient access to a bike route, or at religious or other locations, or at government controlled locations. Individuals or organizations may decide to be a purveyor of the mode transition location and enter mode transition location information and availability into the system outlined herein. Information about mode transition locations may be provided to the user via a textual list, or by a graphical representation or graphical user interface (GUI), usually on a map on the user device or another device, or by a combination of graphical and textual elements. Corresponding routes may also be displayed. Reservations for rentable items may be offered. Rentable items offered and purchasable items offered may vary between different mode transition locations. Personal roadway transportation vehicles offered as rentable items may be owned by the purveyor or another third party, or may be owned by the app manager. The system (either the server, or the user device) may be configured to suggest one or more mode transition locations based in some cases on considerations which may include the user's current location, system parameters, user requirements, user preferences, and/or on the user's entry of a starting address and a destination address. The user may enter information using a keypad, a virtual keypad, voice recognition, or other methods of formulating words, or by touching a touch-sensitive screen on a display, tapping, moving, holding and dragging, sliding along a virtual track, toggling, or by clicking on a display with a computer mouse or other device. A user's profile may contain user requirements, which are generally items that are required, and not open to changing, may include items such as a type of second mode of transportation required (eg. would ride a bicycle, but would not ride a scooter), a maximum cost they are willing to pay, a maximum travel distance they prefer to ride a bicycle and so forth. User preferences may include items that are preferred, but which may be overlooked, such as a cost target range, a ideal distance traveled by second mode of transportation, and so forth.

The system may be configured to allow the user to change the suggested mode transition location to a selected mode transition location, with one example method including touching, tapping, or dragging an icon representing the suggested mode transition location or the route to a different mode transition location on a touch-sensitive screen. The system may provide the user navigation directions tailored for the appropriate mode from the starting address to the mode transition location, and/or from the mode transition location to the destination address, as well as the reverse direction. In addition, the system may provide access, such as unlocking a lock or opening a vehicle locker, to the personal roadway transportation vehicle. Finally, travel by the user may require the transfer between a second mode of transportation and a first mode of transportation, with the initial mode being the second mode, and the following mode being the first mode. The word “between” should not be considered to be directional, and the use of “first” and “second” indicate a mode of travel, not an order in which they are used.

### BRIEF DESCRIPTION OF THE DRAWINGS

This invention has additional advantages and features which will be apparent from the accompanying drawings, in which:

FIG. 1 depicts a block diagram of one example multi-modal travel system showing a route from a starting address to a destination address through a mode transition location in accordance with the embodiments of the present invention.

FIG. 2 depicts a simplified block diagram of one example flow of information between the various components that may be used in accordance with the embodiments of the present invention.

FIG. 3 depicts one example of a simplified block diagram of the user work flow for a multi-modal travel system which provides mode transition locations, a reservations systems for rentable items, and a route with navigation directions in accordance with the embodiments of the present invention.

FIG. 4 depicts a block diagram of one example of a computing environment for multi-modal travel from a starting address to a destination address which provides a suggested mode transition location and route in accordance with the embodiments of the present invention.

FIG. 5 depicts a simplified block diagram of one example of a computing method for determining the suggested mode transition location in accordance with the embodiments of the present invention.

FIG. 6 depicts a simplified map diagram of one example of a first step in determining the suggested mode transition location in accordance with the embodiments of the present invention and is the first of a sequence of four figures.

FIG. 7 depicts a simplified map diagram of one example of a second step in determining the suggested mode transition location in accordance with the embodiments of the present invention and is the second of a sequence of four figures.

FIG. 8 depicts a simplified map diagram of one example of a third step in determining the suggested mode transition location in accordance with the embodiments of the present invention and is the third of a sequence of four figures.

FIG. 9 depicts a simplified map diagram of one example of a fourth step in determining the suggested mode transition location in accordance with the embodiments of the present invention and is the fourth of a sequence of four figures.

FIG. 10 depicts a simplified diagram of one example of a personal roadway transportation vehicle communicating with the user device or purveyor's device, and the server in accordance with the embodiments of the present invention.

FIG. 11 depicts a simplified diagram of one example of some of the various computer form factors that may be used in accordance with the embodiments of the present invention.

FIG. 12 depicts a simplified diagram of one example of the starting address, the route, the mode transition location, personal motorized highway transportation vehicles, personal roadway transportation vehicles, and the destination address in accordance with the embodiments of the present invention.

FIG. 13 depicts a plan view of one example of a display on the user device where the user enters user preferences including which modes will be used in accordance with the embodiments of the present invention.

FIG. 14 depicts a plan view of one example of a display on the user device where the user ranks the importance of user preferences and/or requirements, as well as entering other user information in accordance with the embodiments of the present invention.

FIG. 15 depicts a plan view of one example of a display on the user device where the user enters user preferences and requirements in accordance with the embodiments of the present invention.

FIG. 16 depicts a plan view of one example of a display on the user device showing a map of the general travel area with mode transition locations in accordance with the embodiments of the present invention.

FIG. 17 depicts a plan view of one example of a display on the user device where the user has entered at least the starting address and destination address, and a suggested mode transition location and a route is displayed in accordance with the embodiments of the present invention.

FIG. 18 depicts a plan view of one example of a display on the user device where the user changes the mode transition location to a location other than the suggested mode transition location and a route is displayed in accordance with the embodiments of the present invention.

FIG. 19 depicts a plan view of one example of a display on the user device which allows the user to make a reservation in accordance with the embodiments of the present invention.

FIG. 20 depicts a plan view of one example of a display on the user device which allows the user to view previous, current, and future reservations in accordance with the embodiments of the present invention.

FIG. 21 depicts a plan view of one example of a display on the user device which allows the user to unlock or otherwise access the personal roadway transportation vehicle in accordance with the embodiments of the present invention.

FIG. 22 depicts a plan view of one example of a display on the user device which provides navigation directions in accordance with the embodiments of the present invention.

FIG. 23 depicts a plan view of one example of a display on the user device which allows the user to either lock or otherwise prevent the riding of the personal roadway transportation vehicle while continuing the rental, or end the rental and lock or otherwise prevent the riding of the personal roadway transportation vehicle in accordance with the embodiments of the present invention.

FIG. 24 depicts a plan view of one example of a display on the user device which allows the user to rate and/or comment in accordance with the embodiments of the present invention.

FIG. 25 depicts a plan view of one example of a display on the purveyor's device which allows the purveyor to rate and/or comment in accordance with the embodiments of the present invention.

FIG. 26 depicts a plan view of one example of a display on the user device which allows the user to communicate with the purveyor in accordance with the embodiments of the present invention.

FIG. 27 depicts a plan view of one example of a display on the user device showing advertising in accordance with the embodiments of the present invention.

FIG. 28 depicts a plan view of one example of a display on the user device showing rental vehicle information in accordance with the embodiments of the present invention.

### DETAILED DESCRIPTION

Embodiments described herein set forth an interactive environment for allowing a user to research and rent rentable items for multi-modal travel. A system, method, and user interface for multi-modal travel is presented wherein a server stores mode transition locations at which a user transfers between a first mode of transportation, such as a car, and a second mode of transportation, such as a bicycle or scooter, and wherein the user can rent parking spaces for vehicles and/or rent second mode of transportation vehicles such as bike share bicycles or scooters; and wherein the system may provide the user with a reservations systems and/or suggested routes and mode transition locations based at least in part on a user location or starting and destination addresses, and the system may provide navigation directions during travel.

In accordance with a first aspect of the present invention, a system for multi-modal travel is presented, the system comprising: a server configured to store—information about one or more mode transition locations at which a user transfers between a first mode of transportation and a second mode of transportation, the first mode of transportation comprising a personal motorized highway transportation vehicle, such as a car or truck, and the second mode of transportation comprising a personal roadway transportation vehicle, such as a bicycle, electric bicycle, scooter, or electric scooter; and a user device, such as a mobile phone or tablet, configured to receive user input comprising a starting address and a destination address, and wherein the server and/or the user device provide the user one or more suggested mode transition locations among the one or more mode transition locations based on a route between the starting address and the destination address. It should be noted that the words “transfers between” does not indicate which mode is being transferred from, and which mode is being transferred to. The use of the words “first” and “second” serves to differentiate the modes of transportation from one another, but does not indicate an order in which they are performed during multi-modal travel.

In accordance with a second aspect of the present invention, a system for multi-modal travel is presented, wherein the server is further configured to store, in association with a mode transition location, information on one or more rentable items available to be rented by the user at the mode transition location.

In accordance with a third aspect of the present invention, a system for multi-modal travel is presented, wherein the one or more rentable items comprises a parking space for the personal motorized highway transportation vehicle.

In accordance with a fourth aspect of the present invention, a system for multi-modal travel is presented, wherein the user device is further configured to receive input to rent the parking space for the personal motorized highway transportation vehicle from a purveyor of the mode transition location, wherein the rental of the parking space may be done directly between the user and the purveyor by way of the system, or the rental may be indirect where the user rents the parking space by way of the system from the app manager, and the app manager rents the parking space from the purveyor.

In accordance with a fifth aspect of the present invention, a system for multi-modal travel is presented, wherein the server is further configured to receive input to list the parking space for the personal motorized highway transportation vehicle for rent by the purveyor of the mode transition location, or from another purveyor.

In accordance with a sixth aspect of the present invention, a system for multi-modal travel is presented, wherein the server is further configured to store, in association with a mode transition location, information on one or more purchasable items available to be purchased by the user at the mode transition location.

In accordance with a seventh aspect of the present invention, a system for multi-modal travel is presented, wherein one or more rentable items comprises a personal roadway transportation vehicle, such as a bicycle, electric bicycle, scooter, electric scooter, motorized bicycle, moped, motor-scooter, or any other personal vehicle appropriate for travel on urban and suburban roadways. The personal roadway transportation vehicle is appropriate for so called “last mile” travel where there may be excess congestion while a personal motorized highway transportation vehicle such as a car or truck may be less efficient, slower, and/or more expensive to operate due to excess traffic, and limited parking.

In accordance with a eighth aspect of the present invention, a system for multi-modal travel is presented, wherein at the termination of a rental of the personal roadway transportation vehicle, the personal roadway transportation vehicle is returned to a location based on geography, to the fleet of personal roadway transportation vehicles available for rental, by a method of terminating the rental. The return based on geography may, for example, require the personal roadway transportation vehicle be returned in a particular city or town, or in a particular region, or to a particular establishment or type of establishment, or to most or any geographic location, as represented by map 96, shown in FIG. 16. A method of terminating the rental may include the locking of a lock that prevents use of the personal roadway transportation vehicle by direct communication between the user device and the personal roadway transportation vehicle, or by communication between the user device and the server and communication between the server and the personal roadway transportation vehicle, or by a manual or physical method, or a combination of manual or physical and electronic methods.

In accordance with a ninth aspect of the present invention, a system for multi-modal travel is presented, wherein at the termination of a rental of the personal roadway transportation vehicle, the personal roadway transportation vehicle is returned to one of the one or more mode transition locations as, for example represented by mode transition locations 25 as shown in FIG. 16.

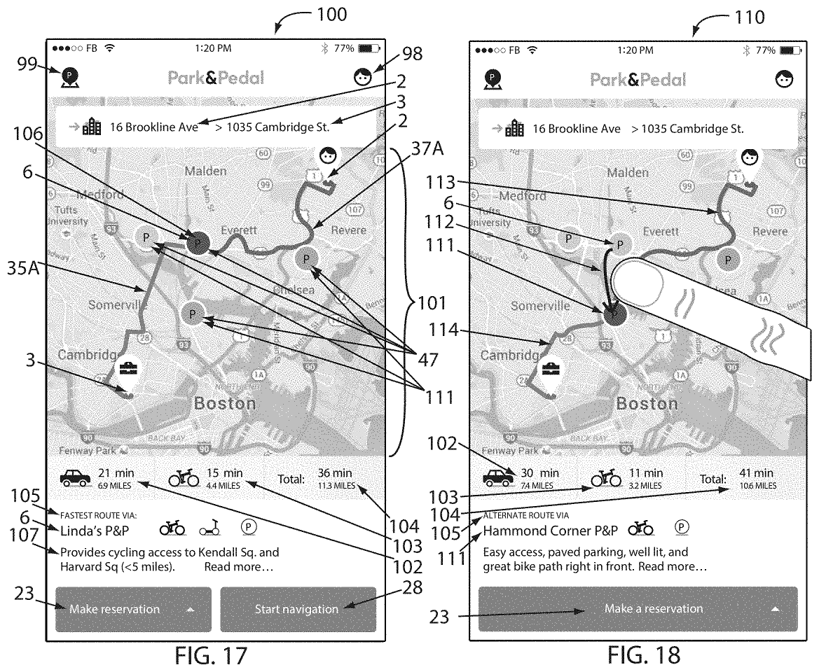

In accordance with a tenth aspect of the present invention, a system for multi-modal travel is presented, wherein at the termination of a rental of the personal roadway transportation vehicle, the personal roadway transportation vehicle is returned to the mode transition location where the rental occurred, as for example represented by suggested mode transition location 6, shown in FIG. 17.

In accordance with a eleventh aspect of the present invention, a system for multi-modal travel is presented, wherein the user device is further configured to receive user input to rent the personal roadway transportation vehicle at the mode transition location. In addition to receiving payment for the personal roadway transportation vehicle, the system to rent the personal roadway transportation vehicle may include the ability to reserve in advance, the unlocking of a lock that prevents use of the personal roadway transportation vehicle by direct communication between the user device and the personal roadway transportation vehicle, or by communication between the user device and the server and communication between the server and the personal roadway transportation vehicle, or by a manual or physical method, or a combination of manual or physical and electronic methods.

In accordance with a twelfth aspect of the present invention, a system for multi-modal travel is presented, wherein the personal roadway transportation vehicle comprises a bicycle or scooter, which include motorized versions of a bicycle and a scooter which include an electric bicycle, electric scooter, gas powered motorized bicycle, and gas powered motorized scooter, as well as any other form of bicycle or scooter.

In accordance with a thirteenth aspect of the present invention, a system for multi-modal travel is presented, wherein one or more rentable items available at the mode transition location comprises a parking space for the personal motorized highway transportation vehicle, and/or a parking space for the personal roadway transportation vehicle, and/or rental of the personal roadway transportation vehicle.

In accordance with a fourteenth aspect of the present invention, a system for multi-modal travel is presented, wherein the user device is further configured to receive user input to rent the personal roadway transportation vehicle at the mode transition location and/or user input to rent the parking space for the personal motorized highway transportation vehicle and/or rent the parking space for the personal roadway transportation vehicle from the purveyor of the mode transition location.

In accordance with a fifteenth aspect of the present invention, a system for multi-modal travel is presented, wherein the server is further configured to store for each mode transition location among the plurality of mode transition locations, at least one of: a location of the mode transition location, a layout of the mode transition location, a type of facility at the mode transition location, financial information for the purveyor, types of rentable items available, cost to rent the rentable items, availability of the rentable items according to date and time, description of the rentable items, limitations regarding rentals of the rentable items, user access to the mode transition location, laws governing the use of the rentable items, rules and regulations for users enforced by the purveyor of the mode transition location, as well as other information.

In accordance with a sixteenth aspect of the present invention, a system for multi-modal travel is presented, wherein the server is further configured to store information about the user comprising at least one of: requirements and/or preferences for modes of the personal roadway transportation vehicle, requirements and/or preferences regarding travel distance on different types of personal roadway transportation vehicles, requirements and/or preferences regarding level of difficulty for travel on different types of personal roadway transportation vehicles, maximum price, price vs. time priority, identifying attributes of the personal motorized highway transportation vehicle, requirements and/or preferences regarding travel distance on the personal motorized highway transportation vehicle, home address, work address, payment information, demographic information, mobile phone number, email address, comments regarding mode transition locations used, rating and/or ranking of a mode transition location used, and ranking by the user of the user preferences and/or user requirements.

In accordance with a seventeenth aspect of the present invention, a system for multi-modal travel is presented, wherein the user device is further configured to provide a user interface for receiving payment information of the user for rental of one or more of the rentable items, and wherein the server is further configured to process payment of the rental of the one or more of the rentable items based on the payment information. In addition, the server may be further configured to allow the user to edit and/or choose a different payment method, enter a promotional code for a discount, or choose what account or credit card to charge. Payment may be made on a rental by rental basis, or using a virtual wallet that is filled initially before a rental, wherein the charge for the rental is deducted from the virtual wallet. Finally, rentable items may be rented for each trip, by distance traveled, or may be rented for a period of time (e.g. unlimited usage for a period of time).

In accordance with a eighteenth aspect of the present invention, a system for multi-modal travel is presented, wherein a suggested mode transition location is selected based on a score according to a set of criteria.

In accordance with a nineteenth aspect of the present invention, a system for multi-modal travel is presented, wherein the user device is further configured to provide to the user of the user device one or more optional mode transition locations meeting the set of criteria and having scores lower than the score of the suggested mode transition location, wherein a lower score indicates a less desirable mode transition location, such as a mode transition location that meets fewer of a set of user preferences than other mode transition locations.

In accordance with a twentieth aspect of the present invention, a system for multi-modal travel is presented, wherein the user device is further configured to receive input of the user selecting one optional mode transition location among the one or more optional mode transition locations to replace the suggested mode transition location.

In accordance with a twenty-first aspect of the present invention, a system for multi-modal travel is presented, wherein the input of the user selecting the optional mode transition location comprises at least one of tapping or clicking on, or proximate to, a icon representing the optional mode transition location on a map, or dragging a line representing the route, or dragging a icon representing the suggested mode transition location to a position at, or proximate to the icon representing the optional mode transition location on the map, wherein the action of tapping, clicking, or dragging can be accomplished on a touch sensitive terminal, or via a mouse or other device displayed on a non-touch sensitive terminal.

In accordance with a twenty-second aspect of the present invention, a system for multi-modal travel is presented, wherein the user device is further configured to provide information to the user regarding the one or more mode transition locations including information on one or more of: travel time and/or distance for the first mode route and the second mode route, at least one of total travel time and total travel distance of the route from the starting address to the destination address, and level of difficulty for the route, and information on one or more rentable items available to be rented at the mode transition location.

In accordance with a twenty-third aspect of the present invention, a system for multi-modal travel is presented, wherein the route comprises: a first mode route which is appropriate for travel by personal motorized highway transportation vehicle such as a car or truck, and a second mode route appropriate for travel by personal roadway transportation vehicle, such as a bicycle or scooter.

In accordance with a twenty-fourth aspect of the present invention, a system for multi-modal travel is presented, wherein the user device displays the route on a map with the first mode route displayed in a first manner and the second mode route displayed in the first manner, or in a second manner, and wherein the first manner is preferably in a first color for the portion traveled by personal motorized highway transportation vehicle, and the second manner is preferably in a second color, for the portion traveled by personal roadway transportation vehicle. However, the first manner may also be the same as the second manner.

In accordance with a twenty-fifth aspect of the present invention, a system for multi-modal travel is presented, wherein the user device displays the mode transition location as an icon on a map in a first manner if the mode transition location meets a first criteria, and in a second manner if the mode transition location meets a second criteria, such as the existence of a reservation at a mode transition location, or the availability, or lack of availability, of personal roadway transport vehicles during a particular time period.

In accordance with a twenty-sixth aspect of the present invention, a system for multi-modal travel is presented, wherein the user device displays the one or more mode transition locations as one or more icons on a map and further displays additional information about one or more of the one or more mode transition locations, such as cost, types of personal roadway transport vehicles available, and so forth.

In accordance with a twenty-seventh aspect of the present invention, a system for multi-modal travel is presented, wherein the user device is configured to provide directions for travel on the route from the starting address to the destination address, or from the destination address to the starting address.

In accordance with a twenty-eighth aspect of the present invention, a system for multi-modal travel is presented, wherein the personal roadway transportation vehicle further comprises a lock, or other use prevention means, which prevents use of the personal roadway transportation vehicle, and wherein the user device is further configured to provide for the locking or the unlocking of the lock, or other use prevention means, thereby controlling usage of the personal roadway transportation vehicle. Such use prevention means may include a lock, individual vehicle storage lockers, group vehicle storage lockers, storage buildings, and other methods of preventing unauthorized use of the personal roadway transportation vehicle. Such locks include locks that only prevent unauthorized riding of the personal roadway transportation vehicle but do not secure the personal roadway transportation vehicle to another anchored object, as well as locks that secure the personal roadway transportation vehicle to another anchored object.

In accordance with a twenty-ninth aspect of the present invention, a system for multi-modal travel is presented, wherein the user device is configured for locking or unlocking of the lock, or other use prevention means, by wireless communication with the personal roadway transportation vehicle and/or the server.

In accordance with a thirtieth aspect of the present invention, a system for multi-modal travel is presented, further comprising a vehicle parking monitoring system and a purveyor's device, wherein the server and/or the user device and/or the purveyor's device is configured to communicate with the vehicle parking monitoring system to monitor the mode transition location, and parking therein of personal motorized highway transportation vehicles, and personal roadway transportation vehicles. Such a vehicle parking monitoring system may include 1) automatic sensors which, without human assistance, report the presence and location of personal motorized highway transportation vehicles and/or personal roadway transportation vehicles at the mode transition location, and 2) the manual reporting of the presence and location of personal motorized highway transportation vehicles and/or personal roadway transportation vehicles at the mode transition location by the purveyor of the mode transition location or by another person.

In accordance with a thirty-first aspect of the present invention, a system for multi-modal travel is presented, wherein the user device is further configured to receive user input to comment on and/or rate and/or rank the mode transition location and/or the one or more rentable items.

In accordance with a thirty-second aspect of the present invention, a system for multi-modal travel is presented, wherein the server and/or another device is further configured to receive input of a purveyor of the mode transition location to comment on and/or rate and/or rank the user.

In accordance with a thirty-third aspect of the present invention, a system for multi-modal travel is presented, wherein the user device consists of a mobile phone, a desktop computer, a notebook computer, a tablet computer, a handheld computer, a personal digital assistant, a media player, or another electronic device configured to receive input by the user.

In accordance with a thirty-fourth aspect of the present invention, a system for multi-modal travel is presented, wherein the server is further configured to store, information on a reservation by the user for the one or more rentable items for a rental at a future time. [D1] Alternatively, rentals of rentable items may be done using an “on-demand” system wherein no reservation is done and/or available through the system, and the rentable item is simply rented on-demand at the time that the rental is desired.

In accordance with a thirty-fifth aspect of the present invention, a system for multi-modal travel is presented, wherein the user device is further configured to receive user input to reserve the one or more rentable items. Furthermore, it may be desirable to allow the user to confirm or cancel a reservation at any point in time, during a specific time period, or on a location-by-location basis as dictated by a purveyor of a mode transition location.

In accordance with a thirty-sixth aspect of the present invention, a system for multi-modal travel is presented, wherein the user device is further configured to provide advertising to the user, the advertising including advertising of a purveyor of the mode transition location as well as third party advertising, app manager advertising, and wherein the advertising might appear on the map display of the suggested mode transition location and the route, or in another location.

In accordance with a thirty-seventh aspect of the present invention, a system for multi-modal travel is presented, further comprising communications means for communications between the purveyor of the mode transition location and the user by means of the user device.

In accordance with a thirty-eighth aspect of the present invention, a system for multi-modal travel is presented, further comprising a purveyor's device to transmit and receive the communications, and wherein the transmitting or receiving of communications does not require the purveyor to disclose contact information such as a phone number associated with the purveyor's device.

In accordance with a thirty-ninth aspect of the present invention, a system for multi-modal travel is presented, wherein the user device is configured to provide the current location of the user device to the server.

In accordance with a fortieth aspect of the present invention, a system for multi-modal travel is presented, wherein the server and/or user device is configured to determine, based on the current location during travel on the route between the starting address and the destination address, one or more functions required by the user at the current location, such as navigation directions, unlocking a personal roadway transportation vehicle, or another function.

In accordance with a forty-first aspect of the present invention, a system for multi-modal travel is presented, wherein the functions required by the user include providing directions for travel on the route, and wherein the server and/or user device provides directions for travel from the starting address to the destination address, or from the destination address to the starting address, depending on proximity of the current location of the user device to the starting address or the destination address.

In accordance with a forty-second aspect of the present invention, a system for multi-modal travel is presented, wherein the server and/or user device is configured to, based on the current location of the user device, determine one or more of: when the user is about to, is in the act of, or has just recently, transferred between the first mode of transportation and the second mode of transportation.

In accordance with a forty-third aspect of the present invention, a system for multi-modal travel is presented, wherein the personal roadway transportation vehicle is configured to send and/or receive communications with the server and/or user device, and/or a purveyor's device.

In accordance with a forty-fourth aspect of the present invention, a system for multi-modal travel is presented, wherein the server and/or user device, and/or purveyor's device is configured to track the personal roadway transportation vehicle location before, during, or after a rental.

In accordance with a forty-fifth aspect of the present invention, a system for multi-modal travel is presented, wherein the user device and/or server and/or purveyor's device is configured to receive information regarding one or more of the location, the identity, or other attributes of one or more personal roadway transportation vehicles from the one or more personal roadway transportation vehicles.

In accordance with a forty-sixth aspect of the present invention, a system for multi-modal travel is presented, wherein the communications may include, in the case when the personal roadway transportation vehicle is partially or fully powered by an electric motor and a battery, the range or battery life of the personal roadway transportation vehicle.

In accordance with a forty-seventh aspect of the present invention, a system for multi-modal travel is presented, wherein the one or more rentable items comprises a parking space for the personal roadway transportation vehicle.

In accordance with a forty-eighth aspect of the present invention, a method for multi-modal travel is presented, the method comprising: storing information about one or more mode transition locations at which a user transfers between a first mode of transportation and a second mode of transportation, the first mode of transportation comprising a personal motorized highway transportation vehicle and the second mode of transportation comprising a personal roadway transportation vehicle; receiving a starting address and a destination address; and determining a suggested mode transition location from among the one or more mode transition locations based on a route between the starting address and the destination address.

In accordance with a forty-ninth aspect of the present invention, a method for multi-modal travel is presented, wherein the method of determining comprises: filtering each mode transition location among the one or more mode transition locations as an acceptable mode transition location or an unacceptable mode transition location, based on user requirements, and/or system parameters.

In accordance with a fiftieth aspect of the present invention, a method for multi-modal travel is presented, wherein the method of determining further comprises: filtering the acceptable mode transition locations based on routes between the acceptable mode transition locations and the destination address, and selecting preferred mode transition locations from among the filtered acceptable mode transition locations based on the user requirements and/or system parameters.

In accordance with a fifty-first aspect of the present invention, a method for multi-modal travel is presented, wherein the method of determining further comprises: filtering the preferred mode transition locations based on routes between the starting address and the preferred mode transition locations, and selecting final mode transition locations from among the filtered preferred mode transition locations based on the user requirements and/or system parameters.

In accordance with a fifty-second aspect of the present invention, a method for multi-modal travel is presented, wherein the method of determining further comprises: scoring the final mode transition locations.

In accordance with a fifty-third aspect of the present invention, a method for multi-modal travel is presented, wherein the method of determining further comprises:

selecting the suggested mode transition location from among the scored final mode transition locations.

In accordance with a fifty-fourth aspect of the present invention, a multi-modal travel method is presented, the method comprising: receiving user input comprising a starting address and a destination address; providing a location of a mode transition location at which a user transfers between a first mode of transportation and a second mode of transportation, based on a route between the starting address and the destination address, wherein the first mode of transportation comprises a personal motorized highway transportation vehicle and the second mode of transportation comprises a personal roadway transportation vehicle.

In accordance with a fifty-fifth aspect of the present invention, a multi-modal travel method is presented, the method comprising: a user interface for choosing modes to be used in the multi-modal travel comprising on/off switches to designate which modes are to be used during travel, wherein a first on/off switch designates the use of a first mode, a second on/off switch designates the use of a second mode, wherein additional switches designate the use of additional modes, and wherein the on/off switches are operated by the user by moving an image of a button from an off position to an on position for all modes to be used during the multi-modal travel.

In accordance with a fifty-sixth aspect of the present invention, a multi-modal travel method is presented, wherein the moving of an image of a button from an off position to an on position is accomplished by swiping a finger across a touch sensitive screen.

In accordance with a fifty-seventh aspect of the present invention, a multi-modal travel method is presented, wherein the moving of an image of a button from an off position to an on position is accomplished by dragging the image of a button using a computer mouse from a first position to a second position.

In accordance with a fifty-eighth aspect of the present invention, a system for multimodal travel is presented, wherein the system comprises: a server configured to store information about one or more mode transition locations at which a user transfers between a first mode of transportation and a second mode of transportation, the first mode of transportation comprising a personal motorized highway transportation vehicle and the second mode of transportation comprising a personal roadway transportation vehicle; and wherein a user device is configured to provide to the user of the user device information about the one or more mode transition locations, wherein the server is further configured to store, in association with a mode transition location, information on one or more rentable items available to be rented by the user at the mode transition location. The word “between” should not be considered to be directional, and the use of “first” and “second” indicate a mode of travel, not an order in which they are used.

In accordance with a fifty-ninth aspect of the present invention, a system for multimodal travel is presented, wherein the server selects a subset of the one or more mode transition locations to be displayed mode transition locations and information about the displayed mode transition locations is provided to the user by way of the user device.

In accordance with a sixtieth aspect of the present invention, a system for multimodal travel is presented, wherein the server selects the displayed mode transition locations based on location of the user device.

In accordance with a sixty-first aspect of the present invention, a system for multimodal travel is presented, wherein the user device is further configured to receive user input comprising a starting address and a destination address, and wherein the server selects the displayed mode transition locations based on the starting address and the destination address.

In accordance with a sixty-second aspect of the present invention, a system for multimodal travel is presented, wherein the information about the displayed mode transition locations is provided to the user in the form of a list of displayed mode transition locations.

In accordance with a sixty-third aspect of the present invention, a system for multimodal travel is presented, wherein the system is further configured to provide the user with additional information about one of the displayed mode transition locations when the one of the displayed mode transition locations is selected by the user, wherein the selection may be by touching a touch sensitive screen, or by using a computer mouse, or by another method.

In accordance with a sixty-fourth aspect of the present invention, a system for multimodal travel is presented, wherein the information about the displayed mode transition locations is displayed at least partially by graphical representation on the user device.

In accordance with a sixty-fifth aspect of the present invention, a system for multimodal travel is presented, wherein the graphical representation comprises a representative icon which represents one of the displayed mode transition locations, and a map, and wherein the representative icon is displayed on the map, and wherein multiple representative icons, representing multiple displayed mode transition locations may be presented on the map.

In accordance with a sixty-sixth aspect of the present invention, a system for multimodal travel is presented, wherein the user device is further configured to receive user input comprising a starting address and a destination address, and wherein a line representing a route is displayed on the map from the starting address to the destination address through the one of the displayed mode transition locations.

In accordance with a sixty-seventh aspect of the present invention, a system for multimodal travel is presented, wherein the system is further configured to provide the user with additional information about the one of the displayed mode transition locations when the representative icon is selected by the user, wherein the selection may be by touching a touch sensitive screen, or by using a computer mouse, or by another method.

Methodology

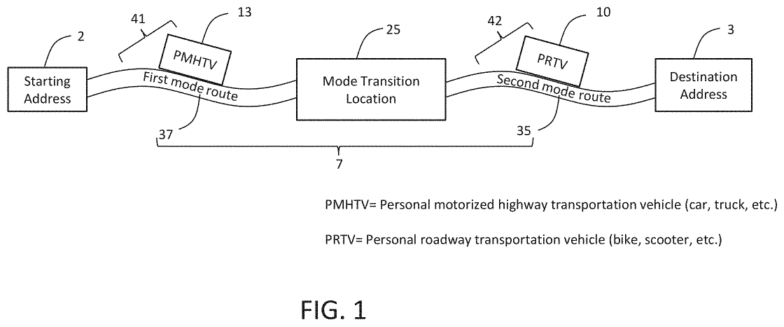

FIG. 1 depicts one example of a simplified block diagram of a multi-modal travel system showing a route 7 from starting address 2 to destination address 3 through mode transition location 25. In this example, a user 8 (not shown) may travel by first mode of transportation 41 by personal motorized highway transportation vehicle 13 on first mode route 37 to mode transition location 25, where the user switches modes and then travels by second mode of transportation 42 by personal roadway transportation vehicle 10 on second mode route 35 to destination address 3 in accordance with the embodiments of the present invention. It will be clear to those skilled in the art that in the case where user 8 is traveling in the opposite direction, for example on a return trip, starting address 2 and destination address 3 may be switched, wherein user 8 starts at destination address 3 and travels to starting address 2. In this case the user transfers between (or in this case “from”) a second mode of transportation 42 and (to) a first mode of transportation 41, with the initial mode being the second mode, and the following mode being the first mode. The word “between” should not be considered to be directional, and the use of “first” and “second” indicate a mode of travel, not an order in which they are used. Therefore, the server 1 is configured to store information about one or more mode transition locations 25 at which a user 8 transfers between a second mode of transportation 42 and a first mode of transportation 41, the second mode of transportation 42 comprising a personal roadway transportation vehicle 10 and the first mode of transportation 41 comprising a personal motorized highway transportation vehicle 13; and wherein a user device 9 (not shown) is configured to provide to the user 8 of the user device 9 information about the one or more mode transition locations 25.

It will be clear to those skilled in the art that the multi-modal travel system set forth herein will contain additional functionality (e.g., commerce, security, user verification, firewalls, authentication and encryption systems, network management tools, load balancers and so forth.) that are not disclosed herein, since they are not directly material to the invention. In addition, communication between participants (e.g. user 8 and purveyor 11), as well as communications with a server, may be done on the internet, on dedicated or private communications networks, local area networks (LAN), or other networks that are not part of the internet. The devices of the participants can be any device that facilitates the functionality of the multi-modal travel system set forth herein. The server 1 and/or user device 9 and/or purveyor's device 12 may contain one or more databases. The use of the terms “user device” and “server” are interchangeable herein as, for example, a server 1 may perform a particular function a first time, and then the user device 9 may perform that same function a second time (e.g. when information is stored in cache in the user device 9).

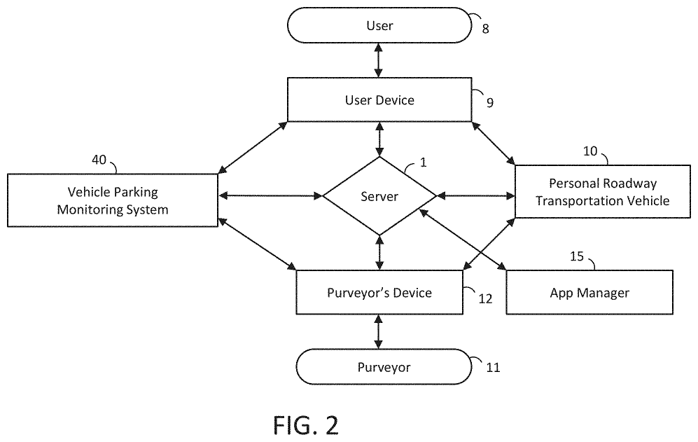

FIG. 2 depicts one example of a simplified block diagram of the flow of information between the various components that may be used in accordance with the embodiments of the present invention. User 8 communicates or interacts with server 1, vehicle parking monitoring system 40, and personal roadway transportation vehicle 10 via a user device 9, such as a smart phone, mobile phone, a cellular phone, a geo-aware cellular telephone, a smart phone, a computer, a tablet, or another electronic device which is incorporated herein when referring to functions performed by the user device 9. In this example, purveyor 11 is the owner or operator of the mode transition location 25, and interacts or communicates using a purveyor's device 12, such as a smart phone, mobile phone, a cellular phone, a geo-aware cellular telephone, a smart phone, a computer, a tablet, or another electronic device which is incorporated herein when referring to functions performed by the purveyor's device 12, with server 1, personal roadway transportation vehicle 10, and vehicle parking monitoring system 40. Purveyor 11 can monitor parking of personal motorized highway transportation vehicles 13 such as cars at the purveyor's 11 mode transition location 25 using vehicle parking monitoring system 40. Purveyor 11 can also monitor personal roadway transportation vehicles 10, such as bicycles or scooters, to track metrics such as availability, location, remaining charge (for electric motor powered vehicles), or other diagnostics or information of interest. Also shown is an app manager 15, who may run the system, and/or perform some or all of the purveyor's 11 functions. App manager 15 is shown with communications only with server 1, however it may be desirable to communicate directly with personal roadway transportation vehicles 10, user device 9, purveyor's device 12, and vehicle parking monitoring system 40 as well and such arrows are not shown to maintain clarity. It will be clear to those skilled in the art that elements shown in FIG. 2 may be deleted or additional elements may be included, and changes to the flow of information may be made without departing from the scope of the invention.

Payments made between a purveyor 11 and the app manager 15 may be made based on ownership of rentable items 62, and other considerations. For example, if the app manager 15 owns a rentable item 62 such as a bicycle, but the purveyor 11 services the bicycle, a certain percentage of the rental payment may be split between the purveyor 11 and the app manager 15. If the purveyor 11 owns the rentable item 62, such as a bicycle, a different percentage of the rental payment may be used. If there is benefit to the purveyor 11 in having a mode transition location 25 at the purveyor's 11 location, then a payment may be made to the app manager 15 for the rights to incorporate a mode transition location 25 into their location.

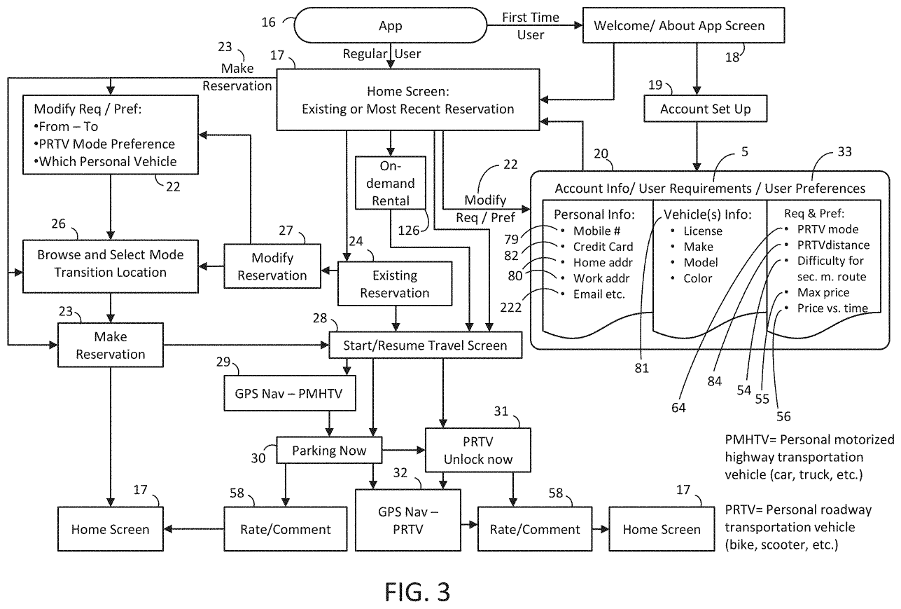

FIG. 3 depicts one example of a simplified block diagram of a user work flow for a multi-modal travel system which provides information about mode transition locations 25, a reservations system for rentable items 62, and a route with navigation directions in accordance with the embodiments of the present invention. A system such as described by an embodiment of FIG. 3 can be implemented using, for example, the elements described with an embodiment of FIG. 1, and the flow of information described with an embodiment of FIG. 2. Accordingly, references made to FIG. 1 and FIG. 2 are for the purposes of illustrating suitable elements, methods, or components for performing a step being described.

User 8, using user device 9 proceeds to open app 16, after having installed app 16 on user device 9. If user 8 is a first time user, app 16 shows welcome screen 18, and may also show account set up 19. If user 8 is a regular user, app 16 shows home screen 17. Home screen 17 typically will consist of a map showing the mode transition location 25 and first mode route 37 and second mode route 35 for an existing reservation 24 for an upcoming date, or for the most recent travel from a past date. In the case where no previous or future reservations exist, a map centered on the current location of user 8 may show with local mode transition locations 25, but no route 7 showing. From home screen 17, user 8 can choose an activity such as a) to modify requirements and/or preferences (step 22), or b) to make a reservation (step 23) or c) go to existing reservation 24 or d) go to start/resume travel screen 28, or e) make an on-demand rental 126.

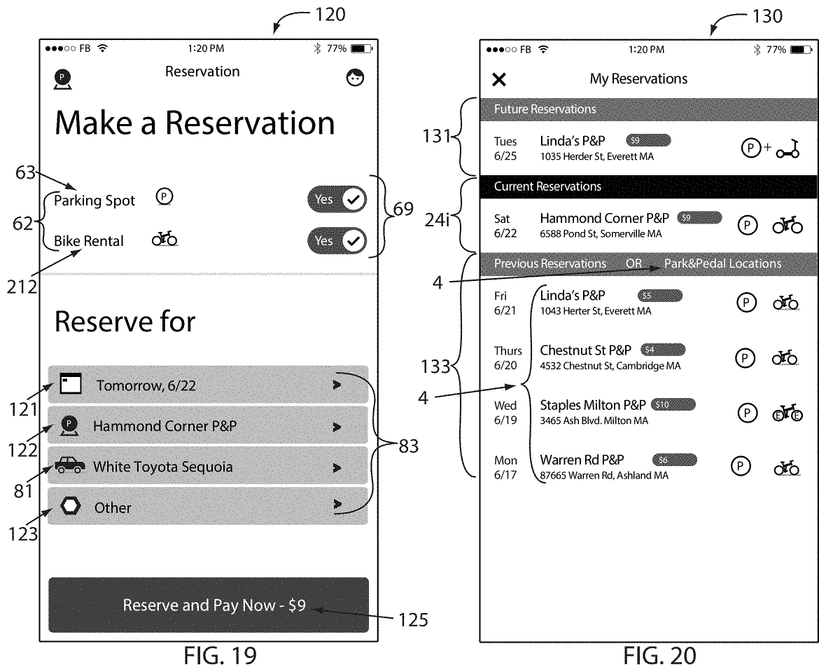

When user 8 chooses to make a reservation (step 23), they can choose to repeat a previous reservation with all user requirements 5 and user preferences 33 remaining unchanged, or they can choose to modify requirements and/or preferences (step 22). Modifying requirements and/or preferences (step 22) may include modifying user requirements 5 and/or user preferences 33, one or both including: requirements and/or preferences for modes of the personal roadway transportation vehicle 64, personal roadway transportation vehicle travel distance 84 on different types of personal roadway transportation vehicles 10, requirements and/or preferences regarding level of difficulty 54 for travel on different types of personal roadway transportation vehicles 10, maximum price 55, price vs. time priority 56, identifying attributes of the personal motorized highway transportation vehicle 81, modes of personal roadway transportation vehicle that are preferred or required 64, home address and work address 80, payment information 82, user mobile phone number 79, email address 222, user comments 173 regarding mode transition location 25 used (FIG. 24), rating and/or ranking of a mode transition location used 171 (FIG. 24), and method of ranking 72 user preferences and/or user requirements (FIG. 14), starting address 2 and destination address 3, mode transition location 25 used, personal roadway transportation vehicle 10 rented or not (FIG. 19), personal roadway transportation vehicle 10 parking space 63 required or not (FIG. 19), personal motorized highway transportation vehicle 13 parking space 63 required or not (FIG. 19), and navigation directions 29, 32 used or not. The modify requirements and/or preferences (step 22) action may be a temporary modification for the current reservation, or may be a modification to account info/user requirements/user preferences screen 20. User 8 may designate which parameters he or she chooses as user preferences 33 versus user requirements 5.

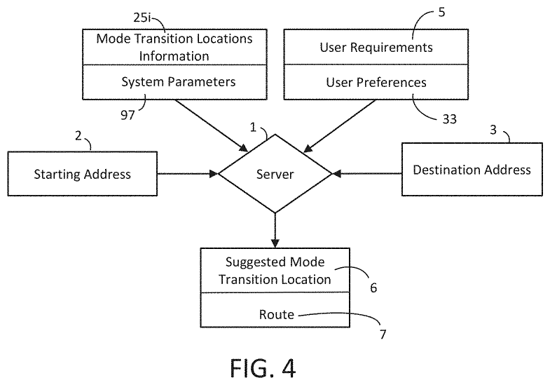

User 8 may browse and select a mode transition location (step 26), wherein the mode transition location 25 may be the suggested mode transition location 6 (see FIG. 4), or another chosen mode transition location 25. User 8 may choose a mode transition location by clicking or tapping on a mode transition location 25 icon on a map, by dragging suggested mode transition location 6 and route 7 icons to a different mode transition location 25 icon on a map, or by another method of choosing (see FIG. 18). Such clicking or tapping and dragging may be accomplished on a touch screen with a user 8 finger, on a computer using a computer mouse, or by another method. User 8 can also use on-demand rental 126 for immediate access to rentable items.

If a reservation is obtained, the user may choose to modify reservation (step 27), or go to start/resume travel screen 28 where navigation directions 29 for personal motorized highway transportation vehicle screen is accessed, a parking now screen 30 is accessed, and a personal roadway transportation vehicle unlock now screen 31 is accessed, depending on if user 8 is about to, is in the act of, or has just recently, transferred between the first mode of transportation 41 and the second mode of transportation 42. Once the user is ready to travel by personal roadway transportation vehicle 10, navigation directions for personal roadway transportation vehicle screen 32 is available. Finally, once travel is completed, user 8 may rate/comment 58 on the mode transition location 25.

It should be noted that FIG. 3 as it is described herein represents only one example of a user work flow. Many additions, deletions, and re-ordering of the steps described are evident, and are considered integral to the invention. For example, FIG. 3 includes a reservations system, however, it might be desirable to have a more basic system with on-demand rentals, but without reservations. It also might be desirable to have a basic system which rents vehicle parking bundled with a personal roadway transportation vehicle 10 rental, and, for example, does not include other functions such as navigation directions 29 or 32, and has a simplified version of the account info/user requirements/user preferences screens 20. Finally, it might be desirable to have a system which does not offer rental parking, but only offers vehicle rentals.

While the most basic form of the invention provides a simple list of mode transition locations 4, a more features rich version may provide a suggested mode transition location 6 based on certain criteria. The certain criteria used may be as simple as suggesting mode transition locations near the current location of the user device 94, or using simply a starting address 2 and a destination address 3, or by way of a more complex methodology. Shown in FIG. 4 is one example of a simplified block diagram of a computing environment for multi-modal travel between a starting address 2 and a destination address 3 which provides a suggested mode transition location 6 and route 7 in accordance with the embodiments of the present invention. Server 1, using a starting address 2 and a destination address 3, in combination with mode transition location information 25i, system parameters 97, and, in some cases, user requirements 5 and user preferences 33, determines a suggested mode transition location 6 and route 7. It will be clear to those skilled in the art that elements shown in FIG. 4 may be changed or deleted or additional elements may be included, without departing from the scope of the invention.

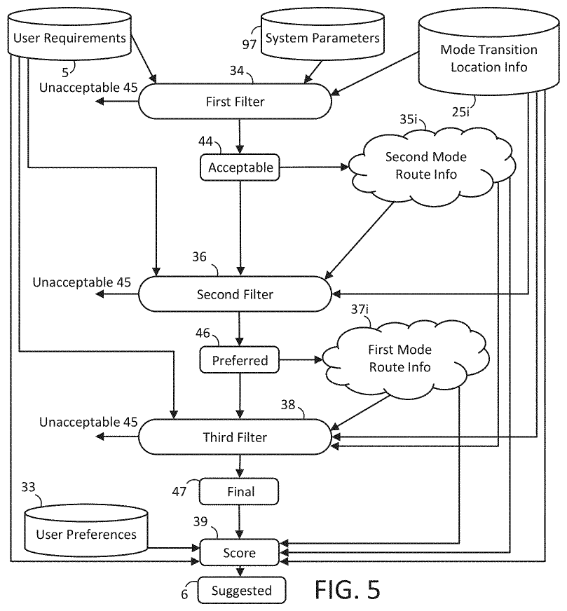

FIG. 5 depicts one example of a simplified block diagram of a computing method for determining one or more suggested mode transition locations 6 and one or more optional mode transition locations 111 in accordance with the embodiments of the present invention. Determining a suggested mode transition location 6, based on a starting address 2 and a destination address 3, and in some cases user requirements 5, user preferences 33, system parameters 97, and mode transition location information 25i, using a fast and economical method is desired. Therefore a method which filters out unacceptable mode transition locations 45 using basic requirements and minimal computations first is advantageous.

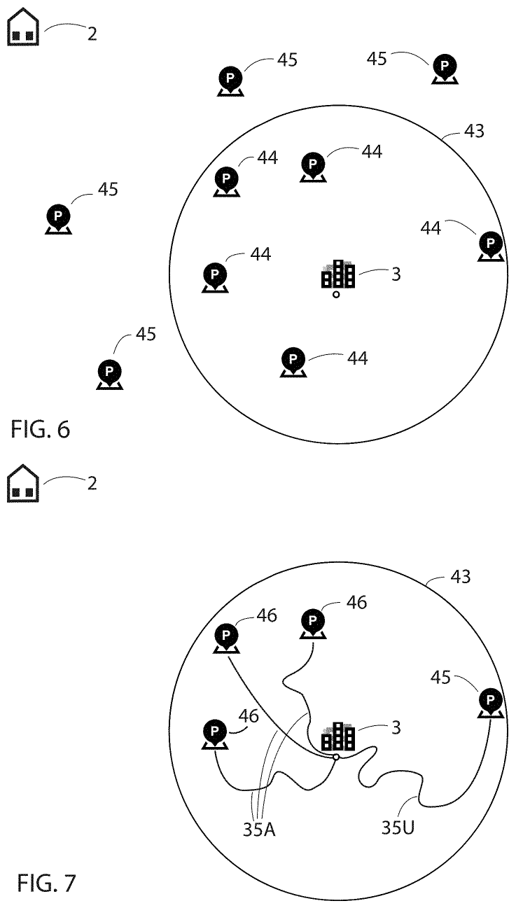

Often, user 8 will have more user requirements 5 and user preferences 33 applicable to the second mode of transportation 42 (for example, the maximum travel distance 21 on a bicycle) than on the first mode of transportation 41. Once general geographically acceptable mode transition locations 44 have been identified based on starting address 2 and destination address 3, it is advantageous to eliminate unacceptable mode transition locations 45 before calculating either the first mode route 37 or the second mode route 35. The first mode route 37 and second mode route 35 may be supplied by a third party by way of API's, and may involve an associated cost. Thus, eliminating all mode transition locations 25 that are located outside a circle 43 drawn on a map (see FIG. 6), with destination address 3 as the center, and a radius equal to the maximum travel distance 21 user 8 has designated in user requirements 5 for personal roadway transportation vehicle 10 travel is accomplished using a first filter 34 is advantageous before involving first mode route 37 and second mode route 35. One example of this is shown in the simplified block diagram of FIG. 5. First filter 34, for example, eliminates all mode transition locations 25 which do not have the personal roadway transportation vehicle 10 required by user 8 as a rentable item 62. In addition, system parameters 97 may also be used to identify unacceptable mode transition locations 45. System parameters 97 may be used at all times, or when few or none of the user requirements 5 or the user preferences 33 have been entered into the system by user 8. System parameters 97 might include, for example, the average distance users prefer to travel by a particular mode of personal roadway transportation vehicle 10, travel conditions, costs 73, promotions, and so forth.

Following first filter 34, acceptable mode transition locations 44 are then, in conjunction with second mode route information 35i, filtered by second filter 36. Second filter 36 uses, in addition to user requirements 5, system parameters 97, and mode transition location information 25i, second mode route information 35i to determine preferred mode transition locations 46. In this way, additional mode transition locations 25 have been found to be unacceptable mode transition locations 45 and eliminated from consideration, before necessitating the calculation of a first mode route 37.

Following second filter 36, preferred mode transition locations 46 are then, in conjunction with first mode route information 37i, filtered by third filter 38. Third filter 38 uses user requirements 5, mode transition location information 25i, system parameters 97, second mode route information 35i, and first mode route information 37i to determine final mode transition locations 47.

Finally, final mode transition locations 47 are then, in conjunction with user preferences 33, scored and ranked by score 39. Score 39 may use both user requirements 5 and user preferences 33, as well as system parameters 97, which may include total transit time, total cost 73, ratings of mode transition locations, ratings or rankings of first mode route 37 and second mode route 35, and other factors to score mode transition locations. The final mode transition location 47 with the highest score 39 is then designated as suggested mode transition location 6, with corresponding route 7. Note, an example of a user requirement 5 might be the requirement that the personal roadway transportation vehicle 10 must be a bicycle, while an example of a user preference 33 might be that the personal roadway transportation vehicle 10 is preferably a bicycle, but can also be a scooter. In this case, final mode transition locations 47 that offer bicycles would score higher than those that offer only scooters, but both would be considered. Final mode transition locations 47 that do not have the highest score 39 may then be used as optional mode transition locations 111 (FIG. 18), from which user 8 may choose to select to replace the suggested mode transition location 6.

In short, FIG. 5 shows an example of a method comprising: determining a suggested mode transition location 6 from among the one or more mode transition locations 25 based on a route 7 between the starting address 2 and the destination address 3, and system parameters 97. The determining of a suggested mode transition location 6 further comprises: filtering, using a first filter 34, each mode transition location 25 among the one or more mode transition locations 25 as an acceptable mode transition location 44 or an unacceptable mode transition location 45; and selecting the suggested mode transition location 6 from among the acceptable mode transition locations 44.

Thereafter, the method further comprises categorizing each of the first filter 34 acceptable mode transition locations 44 as either a: second filter 36 preferred mode transition location 46, or a unacceptable mode transition location 45, the method comprising: fetching second mode route info 35i which extends from the first filter 34 acceptable 44 mode transition location to the destination address 3, and using the second mode route information 35i, in conjunction with mode transition location information 25i, system parameters 97, and the user requirements 5, categorize each first filter 34 acceptable mode transition location 44 as: unacceptable mode transition location 45, for a mode transition location that does not meet one or more user requirements 5, or a: second filter 36 preferred mode transition location 46, for all others.

Thereafter, the method further comprises categorizing each of the second filter 36 preferred mode transition locations 46 as either a: third filter 38 final mode transition location 47, or a unacceptable mode transition location 45, the method comprising: fetching first mode route information 37i which extends from the starting address 2 to the second filter 36 acceptable mode transition location 44, and using the first mode route information 37i, in conjunction with mode transition location information 25i, system parameters 97, and at least some of the second mode route info 35i and at least one of the user requirements 5, categorize each second filter 36 preferred mode transition location 46 as: unacceptable mode transition location 45, for a mode transition location that does not meet one or more user requirements 5, or a: third filter 38 final mode transition location 47, for all others.

Thereafter, the method further comprises scoring the third filter 38 final mode transition locations 47 using at least some of: user preferences 33, user requirements 5, mode transition location information 25i, second mode route information 35i, and first mode route information 37i, to assign a score 39 to the third filter 38 final mode transition locations 47.

Finally, the third filter 38 final mode transition location 47 which meets the most user preferences 33, user requirements 5 and system parameters 97 generating the highest score 39 is selected as the suggested mode transition location 6.

App 16 may be configured to communicate with one or more other applications, databases, websites, and other sources of information using application programming interfaces (API). In this way, some information, such as second mode route information 35i and first mode route information 37i may be provided by a third party, or external source.

In alternate embodiments, a different technique may be used to determine one or more suggested mode transition locations 6. It will be clear to those skilled in the art that variations on this method are possible, such as there being no user preferences 33 and/or user requirements 5 considered, or there being no system parameters 97 that are considered.

FIG. 6 to FIG. 9 are a sequence of graphical representations of one example of the example method outlined in FIG. 5, and assumes that a starting address 2, a destination address 3, and a personal roadway transportation maximum travel distance 21 is known for the user. It will be clear to those skilled in the art that elements shown in FIGS. 6-9 may be changed or deleted or additional elements may be included, without departing from the scope of the invention. FIG. 6 depicts a simplified map diagram of first filter 34 in determining the one or more suggested mode transition locations 6 in accordance with the embodiments of the present invention and is the first of a sequence of four figures. A circle 43 is drawn on a map which encompasses circle 43, starting address 2 and destination address 3, with destination address 3 as the center of circle 43. Circle 43 is drawn with a radius equal to user requirement 5 for the personal roadway transportation maximum travel distance 21. Mode transition locations 25 fall either as inside the circle 43, and are acceptable mode transition locations 44, or outside the circle 43, and are unacceptable mode transition locations 45.

FIG. 7 is the second of a sequence of four figures and depicts one example of a simplified map diagram of a second filter 36 in determining the one or more suggested mode transition locations 6 in accordance with the embodiments of the present invention. Second mode route 35 is calculated for each acceptable mode transition location 44, and compared with second filter 36 criteria such as user requirements 5 for personal roadway transportation maximum travel distance 21 and/or any relevant system parameters 97. Second mode routes 35 are then filtered into acceptable second mode route 35A or unacceptable second mode route 35U based on meeting the second filter 36 requirements. Associated mode transition locations 25 are likewise filtered to be unacceptable mode transition locations 45, or preferred mode transition locations 46.

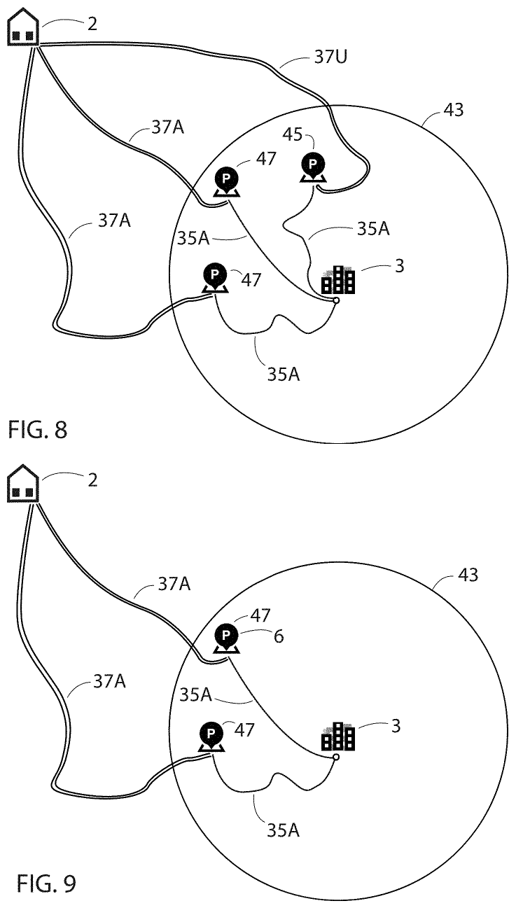

FIG. 8 is the third of a sequence of four figures and depicts one example of a simplified map diagram of a third filter 38 in determining the one or more suggested mode transition locations 6 in accordance with the embodiments of the present invention. First mode route 37 is calculated for each preferred mode transition location 46, and compared with third filter 38 criteria such as user requirements 5 and/or any relevant system parameters 97. First mode routes 37 are then filtered into acceptable first mode route 37A or unacceptable first mode route 37U based on meeting the criteria. Associated mode transition locations 25 are likewise filtered to be unacceptable mode transition locations 45, or final mode transition locations 47.

FIG. 9 is the fourth of a sequence of four figures and depicts one example of a simplified map diagram of a fourth step of assigning a score 39 in determining the one or more suggested mode transition location 6 in accordance with the embodiments of the present invention. Each final mode transition location 47 is assigned a score 39 based at least in part on a set of criteria including user requirements 5, user preferences 33, system parameters 97, mode transition location information 25i, and other ratings and rankings associated with the acceptable first mode route 37A, final mode transition location 47, and acceptable second mode route 35A. The one or more final mode transition locations 47 with the highest score 39 is, or are, chosen to be one or more suggested mode transition locations 6, wherein a higher score 39 indicates a more desirable mode transition location, such as a mode transition location that meets more of the set of desired criteria than other mode transition locations. In FIG. 9 only one suggested mode transition location 6 is shown, but additional locations could be shown.

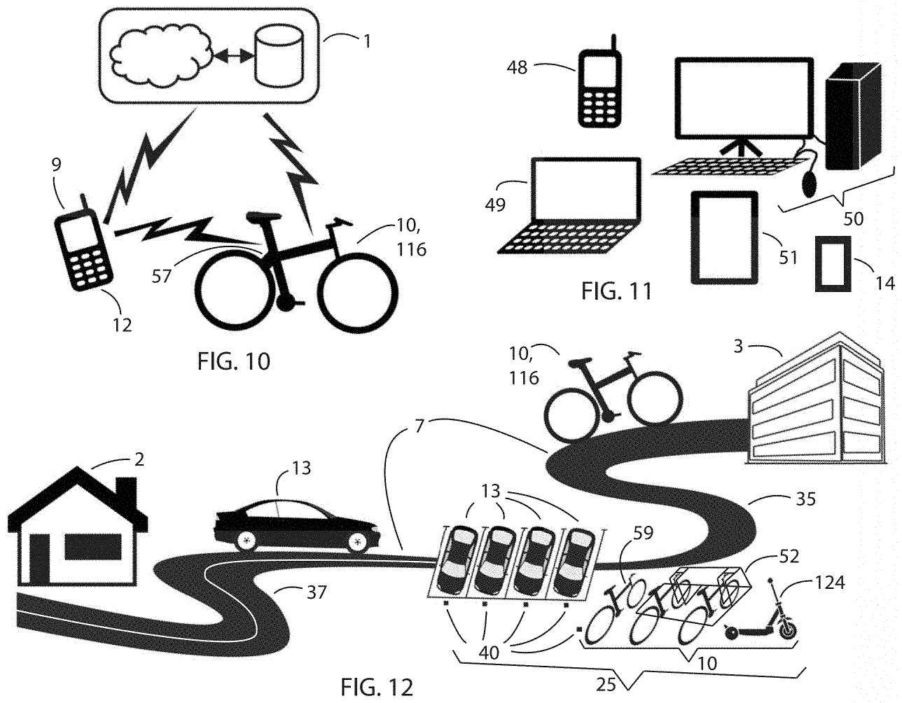

FIG. 10 depicts one example of a simplified diagram of a personal roadway transportation vehicle 10, in this case a bicycle 116, communicating with the user device 9 or purveyor's device 12, and the server 1 in accordance with the embodiments of the present invention. In addition, shown is communications between the user device 9 or purveyor's device 12 and the server 1. Personal roadway transportation vehicle 10 further comprises a lock or other use prevention means 57, which prevents use of the personal roadway transportation vehicle 10, and wherein the user device 9 is further configured to provide for the unlocking of the lock or other use prevention means 57 to allow use of the personal roadway transportation vehicle 10. Lock or other use prevention means 57 may be operated remotely (e.g. by QR Code, Bluetooth, and so forth.) by user device 9 or purveyor's device 12, and/or may be operated manually. Lock or other use prevention means 57 may also be configured to automatically engage/lock when personal roadway transportation vehicle 10 is, in the case where it incorporates a battery, plugged in to recharge. It will be clear to those skilled in the art that elements shown in FIG. 10 may be changed or deleted or additional elements may be included, without departing from the scope of the invention.

FIG. 11 depicts one example of a simplified diagram of various computer form factors that may be used in accordance with the embodiments of the present invention as server 1, user device 9, or purveyor's device 12. Shown as examples of various computer form factors are mobile phone 48, laptop computer 49, desktop computer 50, tablet 51, and other electronic device 14. Additional computer form factors or user interface devices, or combinations thereof, shown, and not shown, whether or not invented yet, may also be used without departing from the scope of this invention. Input elements including one or more fingers, a computer mouse, a stylus, a pen, a pencil, an audio sound, and so forth, or multiple touch objects used simultaneously, may be used.

FIG. 12 depicts one example of a simplified diagram showing a starting address 2, route 7—consisting of first mode route 37 and second mode route 35, mode transition location 25, personal motorized highway transportation vehicles 13, vehicle parking monitoring system 40 for one or both of personal motorized highway transportation vehicle 13 and/or personal roadway transportation vehicle 10, personal roadway transportation vehicles 10 including bicycle 116 and scooter 124, and destination address 3, in accordance with the embodiments of the present invention. Personal roadway transportation vehicles 10 can use docking/storage system 52 at mode transition location 25, or at another location, or can use a dockless system which does not require infrastructure, and does not require the personal roadway transportation vehicle 10 to be put into or docked to any kind of docking/storage system 52. A minimal docking system is also possible, such as a bicycle rack with charging ports for charging vehicle batteries. Also shown is the rental of parking for a personal roadway transportation vehicle owned by user 59. This is a bicycle owned by the user that is stored for a period of time at the mode transition location 25 wherein a parking rental fee is charged. It will be clear to those skilled in the art that elements shown in FIG. 12 may be changed or deleted or additional elements may be included, without departing from the scope of the invention.

User Interface Examples

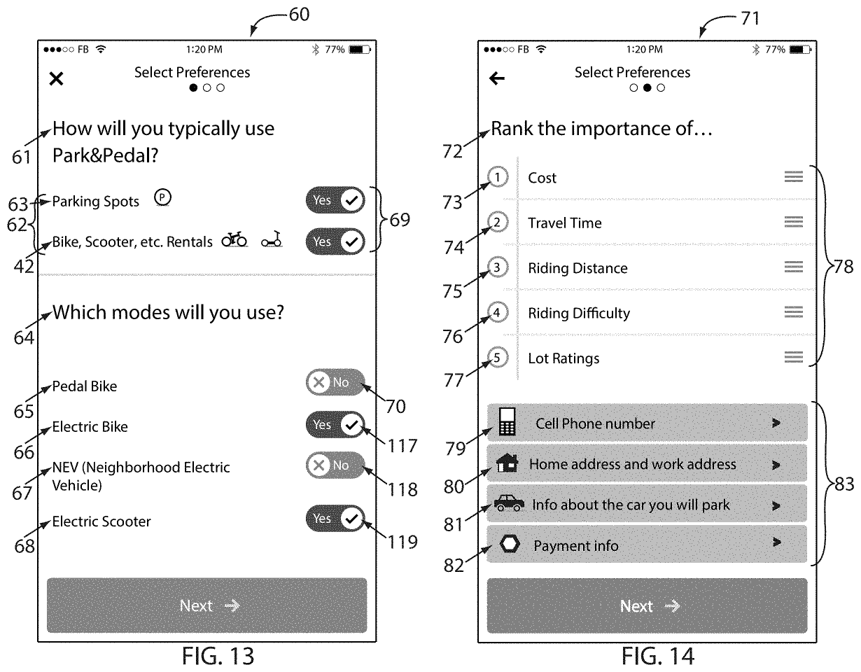

FIGS. 13-24 and FIGS. 26-27 illustrate examples of user interfaces on a user device 9 for interactive environments that enable the user to choose a route 7, and rent and/or reserve rentable items 62 during multi-modal travel according to the embodiments of the present invention. It will be clear to those skilled in the art that elements shown in FIGS. 13-24 and FIGS. 26-27 may be changed or deleted or additional elements may be included, without departing from the scope of the invention. For example, embodiments are shown depicted on a mobile phone or smart phone, however, these embodiments can equally be displayed by way of a desktop or laptop computer or other electronic device. FIG. 13 depicts user preferences and user requirements first interface 60 as an example of a user interface method for choosing modes to be used in the multi-modal travel planning comprising on/off switches 69 to designate which services are to be used during travel. The modes of personal roadway transportation vehicle that are preferred or required 64 are selected using first on/off switch 70 to designate the use of a first mode 65 (shown as a pedal bike), a second on/off switch 117 designates the use of a second mode 66 (shown as an electric bike), wherein additional on/off switches 118 and 119 designate the use of additional modes, such as third mode 67 and fourth mode 68, and wherein the on/off switches are operated by user 8 by moving an image of a button from an off position 70 to an on position 117 for modes to be used during the multi-modal travel. Furthermore, the moving of an image of a button from an off position 70 to an on position 117 may be accomplished by swiping a finger across a touch sensitive screen, or may be accomplished by dragging the image of a button using a computer mouse from a first position to a second position. User preferences and user requirements first interface 60 allows user 8 to designate typical use 61 by choosing which rentable items 62 he or she will typically require. Rentable items 62 may include parking space 63, and which modes of personal roadway transportation vehicle that are preferred or required 64 including second mode of transportation 42 vehicles, which may include pedal bicycle, electric bicycle, NEV (neighborhood electric vehicle), electric scooter, or other personal roadway transportation vehicles 10 such as mopeds, motor-scooters, single wheel and tandem wheel vehicles, or any other personal vehicle appropriate for travel on urban and suburban roadways. User 8 may use on/off switches 69 to choose which rentable items 62 will be typically required, or may use another method. It should be noted that a system may not offer such a broad array of services as shown, or may offer more services than those listed, or may offer them in a different way, without departing from the scope of this invention. Other modes of second mode of transportation 42 are not shown, but are within the scope of this invention.

FIG. 14 depicts an example plan view of user preferences and user requirements second interface 71 comprising a user interface method of ranking 72 user preferences and user requirements including one or more of cost 73, travel time 74, riding distance 75, riding difficulty 76, and lot ratings 77 using re-ranking selection feature 78 which allows the user to drag each line item user preference 33 and/or user requirement 5 to a different position in the ranking, thereby allowing user 8 to rank the importance of the user preferences 33 and/or user requirements 5. In addition, FIG. 14 allows a user interface to enter other user information including one or more of user mobile phone number 79, home address and work address 80, identifying attributes of the personal motorized highway transportation vehicle 81, and payment information 82 using additional information arrows 83 to open additional user interface options in accordance with the embodiments of the present invention. User 8 may use re-ranking selection feature 78 and additional information arrows 83 to choose items, or may use another method.

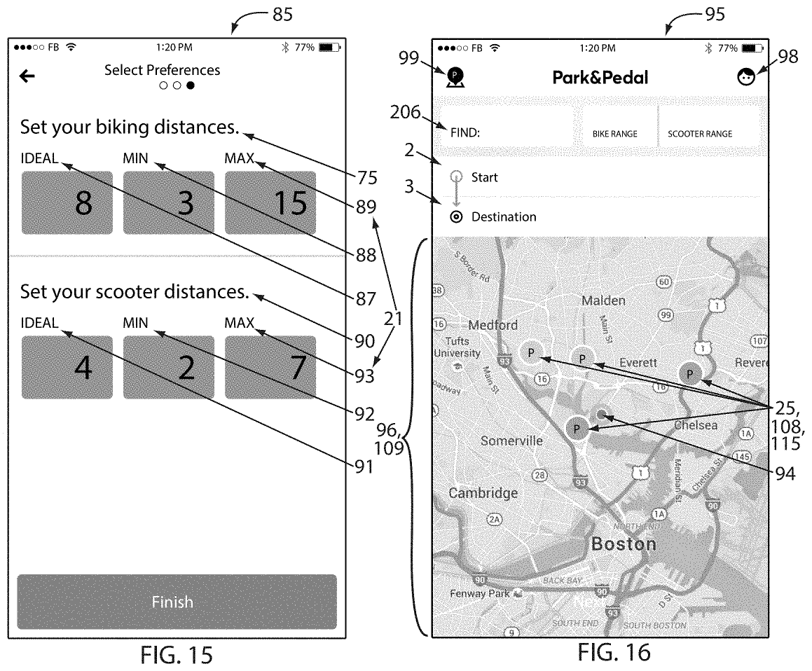

FIG. 15 depicts a plan view of an example user interface method showing user preferences and user requirements third interface 85 wherein user 8 enters user preferences 33 and user requirements 5 in accordance with the embodiments of the present invention. User preferences 33 may include one or more of second mode of transportation 42, riding distances 75, including, in the user interface shown, ideal biking distance 87, minimum biking distance 88, and second mode of transportation scooter distances 90, including ideal scooter distance 91, and minimum scooter distance 92. User requirements may also include one or more of second mode of transportation maximum travel distance by bicycle 89, and second mode of transportation maximum travel distance by scooter 93 whereas a maximum travel distance may be considered a requirement that must be met, while a ideal or minimum distance may be considered a preference which carries a higher score 39 if it is met, but may not be a requirement. Second mode of transportation maximum travel distance by bicycle 89, and travel distance by scooter 93 are examples of personal roadway transportation vehicle maximum travel distance 21. Other modes of second mode of transportation 42 are not shown, but are within the scope of the enclosure.

FIG. 16 depicts a plan view of an example first time user interface 95, with map 96, current location of the user device 94, and mode transition locations 25. This is an example of the user device 9 opening app 16 for the first time, when there are no previous or existing reservations 24 or rentals stored on server 1. As shown there is no starting address 2 or destination address 3 entered. Map 96 may default to showing the general area with the current location of the user device 94 generally in the center. Also shown are go to user account preferences and requirements button 98, and go to reservations overview screen button 99 in accordance with the embodiments of the present invention. A first time user might also be shown, prior to first time user interface 95, a welcome screen 18 (FIG. 3), and various user preferences 33 and user requirements 5 interfaces including user preferences and user requirements first, second, and third interfaces, respectively 60 (FIG. 13), 71 (FIG. 14), and 85 (FIG. 15). Once user 8 has made a reservation (step 23 in FIG. 3), first time user interface 95 may no longer show.

Alternatively, FIG. 16 also depict a plan view of an example user interface home screen of a basic system where the system comprises: a server 1 configured to store information about one or more mode transition locations 25 at which a user transfers between a first mode of transportation 41 and a second mode of transportation 42, the first mode of transportation 41 comprising a personal motorized highway transportation vehicle 13 and the second mode of transportation 42 comprising a personal roadway transportation vehicle 10; and a user device 9 configured to provide to a user 8 of the user device 9 information about the one or more mode transition locations 25, wherein the server 1 is further configured to store, in association with a mode transition location 25, information on one or more rentable items 62 available to be rented by the user 8 at the mode transition location 25. As shown in FIG. 16 the server may select a subset of the one or more mode transition locations 25 to be displayed mode transition locations 108 and information about the displayed mode transition locations 108 is provided to the user 8. The server 1 may select the displayed mode transition locations 108 based on current location of the user device 94 or may be configured to receive user input comprising a starting address 2 and a destination address 3, and wherein the server 1 selects the displayed mode transition locations 108 based on the starting address 2 and the destination address 3. The server 1 may display the information about the displayed mode transition locations 108 at least partially by graphical representation 109 on the user device 9, wherein the graphical representation 109 includes a representative icon 115 which represents a displayed mode transition location 108, and which is displayed on graphical representation 109, in this case as map 96. The system may be further configured to display a line representing a route 7 (not shown) on the map 96 from the starting address 2 to the destination address 3 through one or more of the displayed mode transition locations 108.

A different example user interface of a most basic home screen is where the information about the displayed mode transition locations 108 is provided to the user 8 in the form of a list, herein represented by list of mode transition locations 4 shown in FIG. 20. The system may be further configured to provide the user 8 with additional information about one of the displayed mode transition locations 108 on the list of mode transition locations 4 when the one of the displayed mode transition locations 108 on the list of mode transition locations 4 is selected by the user 8.

The map 96 shown in FIG. 16, as well as other maps in the present disclosure, may, using well known techniques, be reduced or enlarged, re-oriented, dragged, or moved to show a different selection of the map using manipulations on a touch screen terminal, or by a computer mouse, or by other means. In addition, the format of the map, such as the number of dimensions (2D, 3D and so forth) may be changed. Mode transition locations 25 may be represented by individual icons, or by a single icon representing multiple mode transition locations 25, or by another method. Icons shown are one example of a possible icon used to represent mode transition locations 25. Icons may be displayed with additional information, such as, for example, the type or number of personal roadway transportation vehicles 10 that are available.

FIG. 16 also shows search function 206, a function that may allow user 8 to search for one or more mode transition locations 25 using at least one of; by name, by category (e.g. only mode transition locations at supermarkets), by rentable items 62 or purchasable items 203 available, by geography, by lot ratings 77, or by another criteria. Search function 206 is only shown in FIG. 16, but may be applicable to any of the user interfaces shown.

FIG. 17 depicts a plan view of an example home user interface screen 100 which may display one of three sets of information based on user 8 previous app 16 usage. It may be displayed first for non-first time users 8 when app 16 is opened. In the case where user 8 has a previous rental or reservation or an existing reservation 24, mode transition location used for previous or current reservation 106 may be shown by auto-populating, allowing user 8 to quickly repeat a previous reservation or rental or access an existing reservation 24 without requiring determining a suggested mode transition location 6. In this case, user 8 simply makes an on-demand rental or a reservation (step 23), or proceeds to start/resume travel screen 28. Starting address 2 and/or destination address 3 may be auto-populated with the current location of user 8, or another location, or user 8 may manually enter the locations in the search query.

Home user interface screen 100 presents a different display if user 8 has entered a starting address 2 and a destination address 3, but does not have any previous or existing reservations 24 or rentals matching the starting address 2 and destination address 3. A suggested mode transition location 6 and a corresponding route 7 consisting of acceptable first mode route 37A and acceptable second mode route 35A may be displayed in accordance with the embodiments of the present invention. Suggested mode transition location 6 may have been determined using a method of determining a suggested mode transition location 6 from among the one or more mode transition locations 25 based, in part, on a route 7 between the starting address 2 and the destination address 3. Other final mode transition locations 47 (FIG. 5) are displayed as optional mode transition locations 111 but usually without corresponding routes. Corresponding to the suggested mode transition location 6, one or more of travel time and/or distance 102 for the first mode route, travel time and/or distance 103 for the second mode route, total travel time and/or distance 104 of the route, basic criteria used for route 105, and additional information 107 may also be displayed. Final mode transition locations 47 (FIG. 5) may be displayed as an icon on map 101 in a first manner if the mode transition location meets a first criteria, and in a second manner if the mode transition location meets a second criteria. Examples of a first criteria and a second criteria are shown where suggested mode transition location 6 has met a first criteria of being selected based on a higher score 39 than other final mode transition locations 47 (FIG. 5). A higher score 39 may be given to a mode transition location which meets more user preferences 33, and/or user requirements 5, and/or other parameters than other final mode transition locations 47 (FIG. 5). Basic criteria used for route 105 shows, in this example, that a fastest route 7 is the top priority used, which may be due to a ranking of importance done for example as shown in FIG. 14. In FIG. 17, the suggested mode transition location 6 is shown in a first manner, being darker, than other mode transition locations which are shown in a second manner, being lighter. Other options include displaying the mode transition location 25 as an icon on a map in a first manner as a first color if the mode transition location meets a first criteria, and in a second manner in a second color if the mode transition location meets a second criteria. Other options include showing different shapes for different mode transition locations, such as including the shape of a bicycle for locations where rentable items 62 include bicycles, and a shape of a scooter for locations where rentable items 62 include scooters, and including the number of individual units available of rentable items 62 at each location. Additional displays including a third manner, a fourth manner, are also possible.

Home user interface screen 100, may show map 101 positioned such that the entire route 35A and 37A, as well as starting address 2 and destination address 3 are included. Map 101 may be changeable by user 8 by moving, rotating, enlarging, reducing, or otherwise manipulating map 101 as the user desires. Such actions may be accomplished using a touch sensitive screen combined with known gestures of the fingers on the touch sensitive screen, or may be accomplished using another method.

When user 8 is viewing home user interface screen 100, he or she has the ability to go to other screens by pressing: go to reservations overview screen button 99 which may display a reservation at a future time or an on-demand rental at the present time, go to user account preferences and requirements button 98, make reservation (step 23) button, and start/resume travel screen 28 button. In addition, user 8 can also select starting address 2 or destination address 3 if a change in either address is desired. In addition, user 8 can also select additional information 107 to find more information on the suggested mode transition location 6 (or mode transition location used for previous or current reservation 106). Finally, user 8 can change the suggested mode transition location 6 (or 106) as shown in FIG. 18.

FIG. 18 depicts a plan view of one example of a home user interface 110 with optional mode transition location chosen. User 8 (finger) is shown changing the mode transition location from suggested mode transition location 6 (or in the case where a previous or existing reservation 24 was showing the change is from mode transition location used for previous or current reservation 106) to optional mode transition location 111. Arrow 112 indicates tapping or clicking on the optional mode transition location 111, or dragging the route 7 (37A, 35A), or dragging the suggested mode transition location 6 (or 106) to the optional mode transition location 111 on a touch sensitive screen. Other methods to change the mode transition location include the use of a computer mouse or another method instead of a touch sensitive screen, rendering the same results. Optional first mode route 113 and optional second mode route 114 are displayed once the change to optional mode transition location 111 is made. In addition, travel time and/or distance 102 for the first mode route, travel time and/or distance 103 for the second mode route, and total travel time and/or distance 104 of the route 7 are updated based on the new selected optional mode transition location 111. Basic criteria used for route 105 is now changed to mirror the change to the optional mode transition location 111.

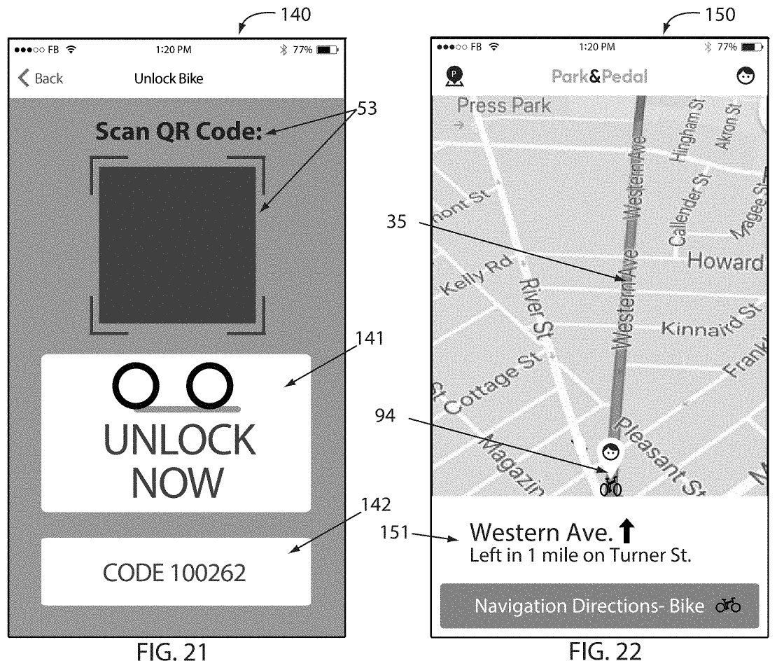

Additional information about optional mode transition location 111 may also be displayed. The novel method of changing the mode transition location shown in FIG. 18 allows user 8 to browse different optional final mode transition locations 47 (FIG. 5) to determine which one best suits his or her needs. Finally, a button to make a reservation (step 23) is provided to make a reservation at a future time or make an on-demand rental at the current time. For on-demand rentals at the current time, a screen similar to FIG. 21 might be shown. For future reservations, a screen similar to FIG. 19 might be shown.

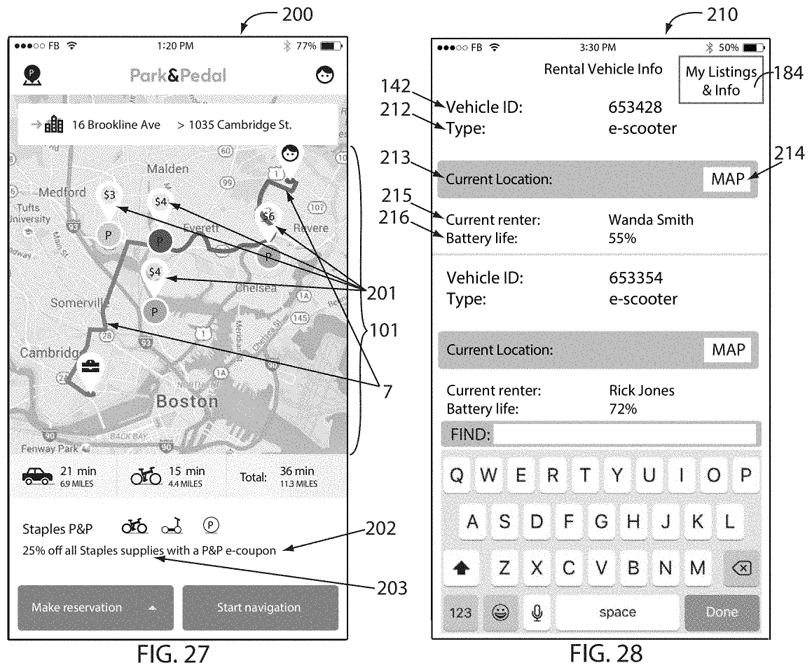

FIG. 19 depicts a plan view of a one example of make a reservation interface 120 where user 8 can make a reservation for rentable items 62 using on/off switch 69, such as a parking space 63 for personal roadway transportation vehicle 10 and/or personal motorized highway transportation vehicle 13 in accordance with the embodiments of the present invention. In this example, user 8 can also make a reservation for a particular type of personal roadway transportation vehicle 212 such as a bicycle (shown), an electric bicycle, a scooter, an electric scooter, a neighborhood electric vehicle (NEV), or another vehicle suitable for travel on the second mode route 35. It will be clear to those skilled in the art that other items such as bicycle helmets, charging for a personal electric vehicle, or other items may also be included (but are not shown) as available for rental and/or reservation on make a reservation interface 120. In addition, purchasable items 203 (FIG. 27) may also be shown. Finally, user 8 may choose to update or alter reservation date information 121, reservation mode transition location 122, identifying attributes of the personal motorized highway transportation vehicle 81, or reservation other information 123 using, for example, expand additional information arrows 83. Finally, reserve and pay now interface 125 button allows user 8 to make and confirm a reservation.

FIG. 20 depicts a plan view of one example of a reservations overview screen 130 on the user device 9 which allows the user to view future reservations information 131, existing reservations information 24i, and previous reservations and/or rentals information 133 in accordance with the embodiments of the present invention. This information may include dates, locations, price paid, rentable items rented, and so forth.

FIG. 20 also depicts an example user interface of a most basic home screen where the information about the displayed mode transition locations 108 is provided to the user 8 in the form of a list, herein represented by list of mode transition locations 4. In this case, information about each mode transition location 25 is included in the list. The system may be further configured to provide the user 8 with additional information about one of the displayed mode transition locations 108 on the list of mode transition locations 4 when the one of the displayed mode transition locations 108 on the list of mode transition locations 4 is selected by the user 8. List of mode transition locations 4 might be preferred in a system were simplicity is desired, and where it may be preferred that the system does not include some or all of the other features set forth herein, such as graphical map displays, reservations systems, the consideration of user preferences 33 and user requirements 5, and the calculation of one or more preferred mode transition locations 46. As shown, list of mode transition locations 4 may contain information on one or more rentable items available to be rented by the user at the mode transition location.

FIG. 21 depicts a plan view of one example of unlock personal roadway transportation vehicle now interface 140 showing for example, unlock personal roadway transportation vehicle now button 141, scan QR code 53, and identity or other attributes 142 of one or more personal roadway transport vehicles. This interface allows the user 8 to unlock or otherwise access the personal roadway transportation vehicle 10 in accordance with the embodiments of the present invention. In the simplest form of the system, after a list of mode transition locations 4 is shown, unlock personal roadway transportation vehicle now interface 140 may be one of the first graphical user interfaces provided, and may be used on an on-demand basis to access the personal roadway transportation vehicle 10. In the case where a simple on-demand rental is being done, scan QR code 53 might show which may unlock access to the personal roadway transportation vehicle 10. In the case where a reservation is made for a specific vehicle, identity, or other attributes 142 of one or more personal roadway transport vehicles helps the user identify the vehicle reserved. Furthermore, this interface may unlock a lock of some sort, or it may also provide access to use of a vehicle in other ways (e.g. opens a door to a bike storage cage where a single vehicle or multiple vehicles, such as bicycles or scooters, are kept). Finally, the current location of the user device 94 may be used to automatically activate unlock personal roadway transportation vehicle now button 141 when, for example, user 8 is geographically proximate to a vehicle reserved.

FIG. 22 depicts a plan view of one example of navigation directions interface 150 which provides user 8 with navigation directions for travel 151 in accordance with the embodiments of the present invention. Navigation directions interface 150 may only be available for one mode of travel, or may be available for multiple modes of travel. Shown are navigation directions by bicycle, however navigation directions for any of the previously listed vehicles suitable for travel on the second mode route 35 may also be shown, as well as navigation directions along the first mode route 37 for any vehicle suitable for travel on first mode route 37. The server 1 and/or user device 9 may be configured to, based on the current location of the user device 94, determine when the user is about to transfer between the first mode of transportation 41 and the second mode of transportation 42, and may default to automatically displaying navigation directions interface 150. Furthermore, the server 1 and/or user device 9 may be configured to, based on the current location of the user device 94, as well as the existence of a current day reservation, default to automatically displaying navigation directions interface 150 when app 16 is opened. The use of navigation directions interface 150 in the system may, or may not be desirable.

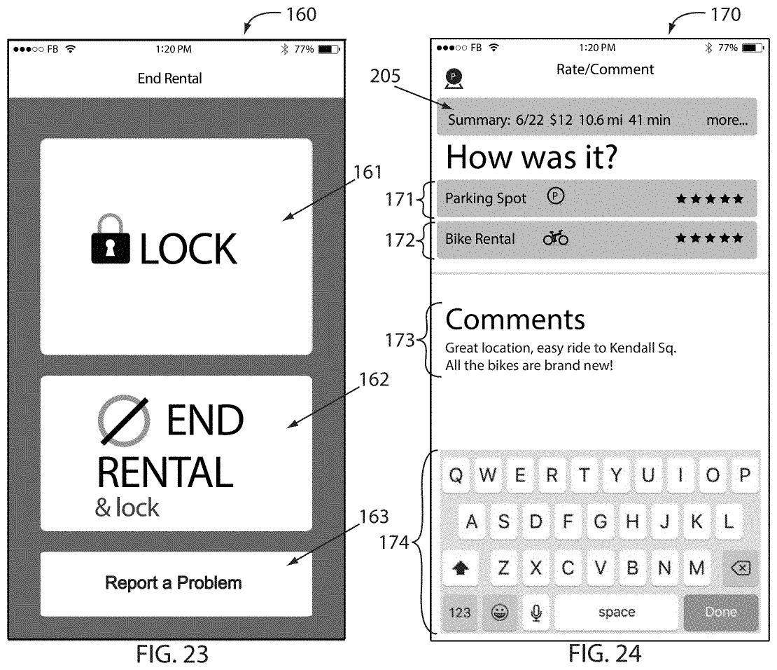

FIG. 23 depicts a plan view of one example of a lock or end rental and lock personal roadway transportation vehicle now interface 160. This interface allows the user to either lock or otherwise prevent the riding of the personal roadway transportation vehicle 10 while continuing the rental, or end the rental and lock or otherwise prevent the riding of the personal roadway transportation vehicle 10 in accordance with the embodiments of the present invention. Lock personal roadway transportation vehicle now button 161 allows the continuation of the rental, while the lock and end rental of personal roadway transportation vehicle now button 162 ends the rental. This screen is novel in that it allows for the locking of the personal roadway transportation vehicle 10 without ending the rental. This is useful when, for example, a commuter rents the vehicle to go to work, and needs to lock it during work hours without ending the rental, thereby insuring availability for the return travel. The system may also be set to engage or disengage the lock and end rental of personal roadway transportation vehicle now button 162 based on the vehicle location or the current location of the user device 94, such as if the location is at the mode transition location 25 where the vehicle was rented. In short, if the vehicle has been returned to the correct location, it may automatically end the rental, while, if the vehicle has not been returned to the correction location, it may not allow the rental to end. It may also be desirable, in the case where the personal roadway transportation vehicle 10 is an electric vehicle that requires charging, to only allow activation of lock and end rental of personal roadway transportation vehicle now button 162 when the vehicle is plugged in to a charger. Alternatively, lock and end rental of personal roadway transportation vehicle now button 162 may be automatically activated if, for example, an electric vehicle is plugged in to a charger at the correct mode transition location 25. Finally, report a problem 163 button offers user 8 the ability to report a problem with a rentable item 62. Furthermore, this interface may lock a lock of some sort, or it may also prevent access or use of a vehicle in other ways (e.g. locks a door to a bike storage cage where a single vehicle or multiple vehicles, such as bicycles or scooters, are kept).

FIG. 24 depicts a plan view of one example of a interface for the user to comment on and/or rate and/or rank the mode transition location and/or the one or more rentable items 170 in accordance with the embodiments of the present invention. This interface may also be used primarily to convey a summary of order 205 as an overview of the recently terminated rental. Additionally, shown for example are parking space rental rating interface 171, personal roadway transportation vehicle rental rating interface 172, and user comments 173 which may be entered using interface for entering information 174. Some, none, or all of the information entered by user 8 herein may be used in the determining of a suggested mode transition location 6 or be made accessible to other users and/or to a purveyor 11 or to other purveyors.

Not shown but clear to those skilled in the art are one or more user interfaces showing information about a recent trip which, for example, could show the user, among other things, an overview of the route 7 traveled, distances traveled by different modes, travel times by different modes, calories burned, time saved verses a single mode of travel, carbon/other emissions saved by not using a first mode vehicle for the entire trip, and cost.

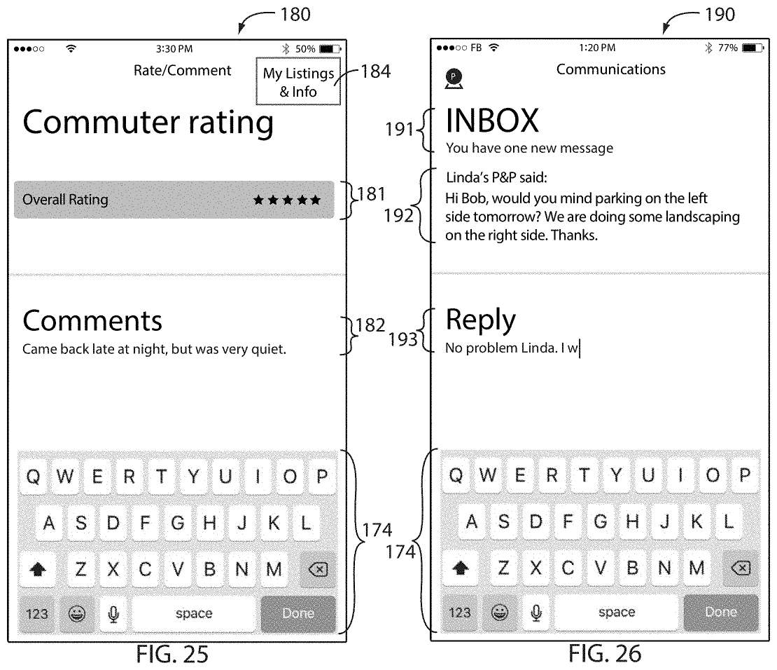

FIG. 25 depicts a plan view of one example of a interface for the purveyor to comment on and/or rate and/or rank the user 180 in accordance with the embodiments of the present invention. Shown is a display on the purveyor's device 12, however a interface for another device may be used. Purveyor's rating interface 181, and purveyor's comments 182 as shown are examples of a purveyors rating of user 8. Also shown is Purveyor's listings and information 184 where purveyor 11 enters and modifies information about his or her mode transition locations 25, rentable items 62, such as the parking space 63 for the personal motorized highway transportation vehicle 13 for rent by the purveyor 11 of the mode transition location 25. In addition, the purveyor 11 may enter, using interface for entering information 174, and the server 1 is further configured to store, for each mode transition location 25 among the plurality of mode transition locations 25, at least one of: a location of the mode transition location 25, a layout of the mode transition location 25, a type of facility at the mode transition location 25, financial information for the purveyor 11 of the mode transition location 25, types of rentable items 62 available, cost 73 to rent the rentable items 62, availability of the rentable items 62 according to date and time, description of the rentable items 62, limitations regarding rentals of the rentable items 62, user access to the mode transition location 25, laws governing the use of the rentable items 62, and rules and regulations for users 8 enforced by the purveyor 11 of the mode transition location 25. It will be clear to those skilled in the art that elements shown in FIG. 25 may be changed or deleted or additional elements may be included, without departing from the scope of the invention.

FIG. 26 depicts a plan view of one example of a interface for communications means 190, with inbox 191, message from purveyor to user 192, and message from user to purveyor 193, and interface for entering information 174. Interface for communications means 190 allows communications between the purveyor 11 of the mode transition location 25 and the user 8 via the user device 9 in accordance with the embodiments of the present invention. Such a communications method is desirable as it allows a purveyor's device 12 to transmit and receive the communications without requiring the purveyor 11 to disclose contact information such as a phone number associated with the purveyor's device 12.

FIG. 27 depicts a plan view of one example of home user interface with advertising 200 in accordance with the embodiments of the present invention. Advertising of a purveyor of the mode transition location 201 is shown with a parking cost 73 being listed on map 101. However, other information could also be shown (e.g. types of vehicles offered for rent, promotions, discounts, number of rentable items available, and so forth.) Also shown is route 7. Also shown is other advertising 202, which may include advertising by purveyor 11, or third parties. Information on one or more purchasable items 203 available to be purchased by the user 8 at the mode transition location 25, such as related items including cycling helmets, clothing, and gear, as well as unrelated items such as groceries and other consumer products may be shown here in other advertising 202, or elsewhere in app 16. Purchasable items 203 may also include the purchase of limited or unlimited use of the rentable items 62, for example, for a period of time, in the form of, for example, a membership.

FIG. 28 depicts a plan view of one example of rentable items information interface 210 in accordance with the embodiments of the present invention. This example is shown on a display on purveyor's device 12, such as a mobile phone, but may also be provided on another type of device. Information provided may include identity, or other attributes 142 of one or more personal roadway transportation vehicles, type of personal roadway transport vehicle 212, current location of personal roadway transportation vehicle 213, map button for current location 214, current user information 215, and range or battery life 216. This allows purveyor 11 to monitor rentable items 62. Not shown but clear to those skilled in the art is a interface showing parking space 63 usage which may use data from vehicle parking monitoring system 40 which may monitor one or both of personal motorized highway transportation vehicle 13 or personal roadway transportation vehicle 10. Finally, purveyor's listings and information 184 may be accessed in order to add or modify purveyor's listings and information 184 including layout of the mode transition location 25, type of facility at the mode transition location 25, financial information for the purveyor of the mode transition location 25, types of rentable items 62 available, availability of the rentable items 62 according to date and time, description of the rentable items 62, limitations regarding rentals of the rentable items 62, user 8 access to the mode transition location 25, laws governing the use of the rentable items 62, and rules and regulations for users enforced by the purveyor 11 of the mode transition location 25. It will be clear to those skilled in the art that elements shown in FIG. 28 may be changed or deleted or additional elements may be included, without departing from the scope of the invention.

It will be clear to those skilled in the art that any functionality shown or described herein as being attributed to the user device 9, may also function on another electronic device, such as server 1. Similarly, any functionality shown or described herein as being attributed to server 1, may also function on another electronic device, such as user device 9. Additional modifications and alternative embodiments, in view of this disclosure, will be apparent to those skilled in the art. It is to be understood that the forms of the inventions shown and described herein are to be taken as exemplary embodiments. Numerous modifications may be made without departing from the scope of this invention. Furthermore, it is contemplated that a particular feature described herein, either individually or as part of an assembly or embodiment, can be combined with other individually described features, or parts of other assemblies or embodiments, even if the other features and embodiments make no mention of the particular feature. Thus, the absence of describing particular combinations should not preclude the inventor from claiming rights to such combinations.

What is claimed is:

1. A system for multi-modal travel, the system comprising:
a server configured to store information about one or more mode transition locations at which a user transfers between a first mode of transportation and a second mode of transportation, the first mode of transportation comprising a personal motorized highway transportation vehicle and the second mode of transportation comprising a personal roadway transportation vehicle; and
a user device configured to receive user input comprising a starting address and a destination address, and wherein at least one of the server and the user device provide the user with one or more suggested mode transition locations among the one or more mode transition locations based on a route between the starting address and the destination address.

2. The system of claim 1, wherein the server is further configured to store, in association with a mode transition location, information on one or more rentable items available to be rented by the user at the mode transition location.

3. The system of claim 2, wherein the one or more rentable items comprises a parking space for the personal motorized highway transportation vehicle.

4. The system of claim 3, wherein the user device is further configured to receive input to rent the parking space for the personal motorized highway transportation vehicle from a purveyor of the mode transition location.

5. The system of claim 4, wherein the is further configured to receive input to list the parking space for the personal motorized highway transportation vehicle for rent by the purveyor of the mode transition location.

6. The system of claim 1, wherein the server is further configured to store, in association with a mode transition location, information on one or more purchasable items available to be purchased by the user at the mode transition location.

7. The system of claim 2, wherein the one or more rentable items comprises the personal roadway transportation vehicle.

8. The system of claim 7, wherein at the termination of a rental of the personal roadway transportation vehicle, the personal roadway transportation vehicle is returned to a location based on geography.

9. The system of claim 7, wherein at the termination of a rental of the personal roadway transportation vehicle, the personal roadway transportation vehicle is returned to one of the one or more mode transition locations.

10. The system of claim 7, wherein at the termination of a rental of the personal roadway transportation vehicle, the personal roadway transportation vehicle is returned to the mode transition location where the rental occurred.

11. The system of claim 7, wherein the user device is further configured to receive user input to rent the personal roadway transportation vehicle at the mode transition location.

12. The system of claim 11, wherein the personal roadway transportation vehicle comprises a bicycle or scooter.

13. The system of claim 2, wherein the one or more rentable items comprises at least one of, a parking space for the personal motorized highway transportation vehicle, and a parking space for the personal roadway transportation vehicle, and rental of the personal roadway transportation vehicle.

14. The system of claim 13, wherein the user device is further configured to receive at least one of: user input to rent the personal roadway transportation vehicle at the mode transition location, and user input to rent the parking space for the personal motorized highway transportation vehicle, and user input to rent the parking space for the personal roadway transportation vehicle from the purveyor of the mode transition location.

15. The system of claim 2, wherein the server is further configured to store for each mode transition location among the plurality of mode transition locations, at least one of: a location of the mode transition location, a layout of the mode transition location, a type of facility at the mode transition location, financial information for the purveyor, types of rentable items available, cost to rent the rentable items, availability of the rentable items according to date and time, description of the rentable items, limitations regarding rentals of the rentable items, user access to the mode transition location, laws governing the use of the rentable items, and rules and regulations for users enforced by the purveyor of the mode transition location.

16. The system of claim 1, wherein the server is further configured to store information about the user, the information about the user comprising: at least one of requirements and preferences for modes of the personal roadway transportation vehicle, at least one of requirements and preferences regarding travel distance on different types of personal roadway transportation vehicles, at least one of requirements and preferences regarding level of difficulty for travel on different types of personal roadway transportation vehicles, maximum price, price vs. time priority, identifying attributes of the personal motorized highway transportation vehicle, home address, work address, payment information, mobile phone number, email address, comments regarding mode transition location used, at least one of rating and ranking of a mode transition location used, and ranking by the user of at least one of the user preferences and the user requirements.

17. The system of claim 1, wherein the user device is further configured to provide a user interface for receiving payment information of the user for rental of one or more of the rentable items, and wherein the server is further configured to process payment of the rental of the one or more of the rentable items based on the payment information.

18. The system of claim 1, wherein a suggested mode transition location is selected based on a score according to a set of criteria.

19. The system of claim 18, wherein the user device is further configured to provide to the user of the user device one or more optional mode transition locations meeting the set of criteria and having scores lower than the score of the suggested mode transition location.

20. The system of claim 19, wherein the user device is further configured to receive input of the user selecting one optional mode transition location among the one or more optional mode transition locations to replace the suggested mode transition location.

21. The system of claim 20, wherein the input of the user selecting the optional mode transition location comprises at least one of tapping or clicking on, or proximate to, a icon representing the optional mode transition location on a map, or dragging a line representing the route, or dragging a icon representing the suggested mode transition location to a position at, or proximate to the icon representing the optional mode transition location on the map, wherein the action of tapping, clicking or dragging can be accomplished on a touch sensitive terminal, or via a mouse or other device displayed on a non-touch sensitive terminal.

22. The system of claim 1, wherein the user device is further configured to provide information to the user regarding the one or more mode transition locations including information on one or more of: travel time and/or distance for the first mode route and the second mode route, at least one of total travel time and total travel distance of the route from the starting address to the destination address, and level of difficulty for the route.

23. The system of claim 1, wherein the route comprises: a first mode route which is appropriate for travel by the personal motorized highway transportation vehicle, and a second mode route appropriate for travel by the personal roadway transportation vehicle.

24. The system of claim 23, wherein the user device displays the route on a map with the first mode route displayed in a first manner and the second mode route displayed in the first manner, or in a second manner.

25. The system of claim 23, wherein the user device displays the mode transition location as an icon on a map in a first manner if the mode transition location meets a first criteria, and in a second manner if the mode transition location meets a second criteria.

26. The system of claim 23, wherein the user device displays the one or more mode transition locations as one or more icons on a map and further displays additional information about one or more of the one or more mode transition locations.

27. The system of claim 1, wherein the user device is configured to provide directions for travel on the route from the starting address to the destination address, or from the destination address to the starting address.

28. The system of claim 7, wherein the personal roadway transportation vehicle further comprises a lock, or other use prevention means, which prevents use of the personal roadway transportation vehicle, and wherein the user device is further configured to provide for the locking or unlocking of the lock or other use prevention means thereby controlling usage of the personal roadway transportation vehicle.

29. The system of claim 28, wherein the user device is configured for locking or unlocking of the lock, or other use prevention means, by wireless communication with at least one of the personal roadway transportation vehicle or the server.

30. The system of claim 5, further comprising a vehicle parking monitoring system, and a purveyor's device, wherein at least one of the server and the user device and the purveyor's device is configured to communicate with the vehicle parking monitoring system to monitor the mode transition location.

31. The system of claim 2, wherein the user device is further configured to receive user input to do at least one of, comment on, and rate, and rank at least one of the mode transition location, and the one or more rentable items.

32. The system of claim 2, wherein at least one of the server and another device is further configured to receive input of a purveyor of the mode transition location to do at least one of comment on, and rate, and rank the user.

33. The system of claim 1, wherein the user device consists of a mobile phone, a desktop computer, a notebook computer, a tablet computer, or another electronic device configured to receive input by the user.

34. The system of claim 2, wherein the server is further configured to store, information on a reservation by the user for the one or more rentable items for a rental at a future time.

35. The system of claim 34, wherein the user device is further configured to receive user input to reserve the one or more rentable items.

36. The system of claim 1, further comprising advertising, wherein the user device is configured to provide advertising to the user, the advertising including advertising of a purveyor of the mode transition location.

37. The system of claim 4 further comprising communications means for communications between the purveyor of the mode transition location and the user by means of the user device.

38. The system of claim 37 further comprising a purveyor's device to transmit and receive the communications, and wherein the transmitting or receiving of communications does not require the purveyor to disclose contact information such as a phone number associated with the purveyor's device.

39. The system of claim 1 wherein the user device is configured to provide a current location of the user device to the server.

40. The system of claim 39 wherein at least one of the server and the user device is configured to determine, based on the current location during travel on the route between the starting address and the destination address, one or more functions required by the user at the current location.

41. The system of claim 40 wherein the functions required by the user include providing directions for travel on the route, and wherein at least one of the server and the user device provides directions for travel from the starting address to the destination address, or from the destination address to the starting address, depending on proximity of the current location of the user device to the starting address or the destination address.

42. The system of claim 39 wherein at least one of the server and the user device is configured to, based on the current location of the user device, determine one or more of: when the user is about to, is in the act of, or has just recently, transferred between the first mode of transportation and the second mode of transportation.

43. The system of claim 6, wherein the personal roadway transportation vehicle is configured to send and receive communications with at least one of the server, and the user device, and a purveyor's device.

44. The system of claim 43 wherein at least one of the server, and the user device, and the purveyor's device is configured to track the personal roadway transportation vehicle location.

45. The system of claim 44 wherein at least one of the user device, and the server, and the purveyor's device is configured to receive information regarding one or more of a location, an identity, or other attributes of one or more personal roadway transportation vehicles.

46. The system of claim 43 wherein the communications may include, when the personal roadway transportation vehicle is partially or fully powered by an electric motor and a battery, the range or battery life of the personal roadway transportation vehicle.

47. The system of claim 2, wherein the one or more rentable items comprises a parking space for the personal roadway transportation vehicle.

48. A multi-modal travel method, the method comprising:
storing information about one or more mode transition locations at which a user transfers between a first mode of transportation and a second mode of transportation, the first mode of transportation comprising a personal motorized highway transportation vehicle and the second mode of transportation comprising a personal roadway transportation vehicle;
receiving a starting address and a destination address;
determining a suggested mode transition location from among the one or more mode transition locations based on a route between the starting address and the destination address.

49. The method of claim 48, wherein the determining comprises:
filtering each mode transition location among the one or more mode transition locations as an acceptable mode transition location or an unacceptable mode transition location, based on at least one of user requirements and system parameters.

50. The method of claim 49, wherein the determining further comprises:
filtering the acceptable mode transition locations based on routes between the acceptable mode transition locations and the destination address, and selecting preferred mode transition locations from among the filtered acceptable mode transition locations based on at least one of the user requirements and the system parameters.

51. The method of claim 50, wherein the determining further comprises:
filtering the preferred mode transition locations based on routes between the starting address and the preferred mode transition locations, and selecting final mode transition locations from among the filtered preferred mode transition locations based on at least one of the user requirements and the system parameters.

52. The method of claim 51, wherein the determining further comprises:
scoring the final mode transition locations.

53. The method of claim 52, wherein the determining further comprises:
selecting the suggested mode transition location from among the scored final mode transition locations.

54. A multi-modal travel method, the method comprising:
receiving user input comprising a starting address and a destination address;
providing a location of a mode transition location at which a user transfers between a first mode of transportation and a second mode of transportation, based on a route between the starting address and the destination address,
wherein the first mode of transportation comprises a personal motorized highway transportation vehicle and the second mode of transportation comprises a personal roadway transportation vehicle.

55. A multi-modal travel method, the method comprising:
a user interface for choosing modes to be used in the multi-modal travel comprising on/off switches to designate which modes are to be used during travel, wherein a first on/off switch designates the use of a first mode, a second on/off switch designates the use of a second mode, wherein additional on/off switches designate the use of additional modes, and wherein the on/off switches are operated by the user by moving an image of a button from an off position to an on position for all modes to be used during the multi-modal travel.

56. The multi-modal travel method of claim 55, wherein the moving of an image of a button from an off position to an on position is accomplished by swiping a finger across a touch sensitive screen.

57. The multi-modal travel method of claim 55, wherein the moving of an image of a button from an off position to an on position is accomplished by dragging the image of a button using a computer mouse from a first position to a second position.

58. A system for multi-modal travel, the system comprising:
a server configured to store information about one or more mode transition locations at which a user transfers between a first mode of transportation and a second mode of transportation, the first mode of transportation comprising a personal motorized highway transportation vehicle and the second mode of transportation comprising a personal roadway transportation vehicle; and
a user device configured to provide to the user of the user device information about the one or more mode transition locations,
wherein the server is further configured to store, in association with a mode transition location, information on one or more rentable items available to be rented by the user at the mode transition location.

59. The system of claim 58 wherein the server selects a subset of the one or more mode transition locations to be displayed mode transition locations and information about the displayed mode transition locations is provided to the user by way of the user device.

60. The system of claim 59 wherein the server selects the displayed mode transition locations based on location of the user device.

61. The system of claim 59 wherein the user device is further configured to receive user input comprising a starting address and a destination address, and wherein the server selects the displayed mode transition locations based on the starting address and the destination address.

62. The system of claim 59 wherein the information about the displayed mode transition locations is provided to the user in the form of a list of displayed mode transition locations.

63. The system of claim 62 further configured to provide the user with additional information about one of the displayed mode transition locations when the one of the displayed mode transition locations is selected by the user.

64. The system of claim 59 wherein the information about the displayed mode transition locations is displayed at least partially by graphical representation on the user device.

65. The system of claim 64 wherein the graphical representation comprises a representative icon which represents one of the displayed mode transition locations, and a map, and wherein the representative icon is displayed on the map.

66. The system of claim 65 wherein the user device is further configured to receive user input comprising a starting address and a destination address, and wherein a line representing a route is displayed on the map from the starting address to the destination address through the one of the displayed mode transition locations.

67. The system of claim 65 further configured to provide the user with additional information about the one of the displayed mode transition locations when the representative icon is selected by the user.
